(19) United States
(12) Patent Application Publication
(10) Pub. No.: US 2003/0216957 A1
(43) Pub. Date: Nov. 20, 2003

(54) Human resource management aid

(75) Inventors: Lloyd Malcolm Florence, Toronto (CA); Paul Michael Brennan, Toronto (CA)

Correspondence Address: TORYS LLP, 79 WELLINGTON ST. WEST, SUITE 3000, TORONTO, ON, M5K 1N2, CA

(73) Assignee: Florence Systems, Inc., Toronto (CA)

(21) Appl. No.: 10/397,694

(22) Filed: Mar. 27, 2003

Related U.S. Application Data
(60) Provisional application No. 60/367,756, filed on Mar. 28, 2002.

(51) Int. Cl. G06F 17/60

(52) U.S. Cl. 705/11; 705/1

(57) ABSTRACT

The invention relates to a human resource management system which includes an objectives module or feature, a notes module or feature and an appraisal module of feature. The objectives module enables the periodic creation and storage of performance objectives for a plurality of employees. The notes module enables the periodic creation and storage of notes relating to the objectives. The notes are correlated with the objectives for view by the user. The appraisal module enables the periodic creation of performance appraisals for the employees. The appraisal module enables the user to selectively incorporate the objectives and selectively incorporate the notes correlated thereto into the appraisal. Consequently, performance appraisals can be produced which encompass the periodic collection of information relating to specific performance objectives, thus facilitating the generation of a high quality appraisal.

This application claims the benefit of U.S. provisional application No. 60/367,756.

### FIELD OF THE INVENTION

This invention relates to a method and apparatus for enhancing and facilitating ongoing personnel management and to a human resource management system.

### BACKGROUND OF THE INVENTION

Management science has become an important area of study. It has been demonstrated that better people management leads to more productive workers, happier workers, less employee turnover, and more effective and efficient organizations. This is the case for both staff, and lower-level management.

Management science is not unique to any one field or domain, but rather any organizational arrangement of persons with one having some supervisory responsibility over another.

Management has been described as 5% leadership and 95% communication. The challenge for many managers is in maintaining the day-to-day communication even when it appears it is not necessary, as this is often the circumstance in which a little communication may avert significant difficulties.

A similar challenge occurs in evaluations or assessments of employees, as these typically involve a recalling of prior communications, regarding the status of objectives, along with occasions of praise and of criticism.

The invention disclosed herein provides a framework and mechanisms for facilitating the day-to-day communication between managers and their employees, as well as assisting managers in maintaining and upgrading management skills, and their employees in job-specific development skills.

### SUMMARY OF THE INVENTION

Heretofore human resources managers have made use of a variety of heterogeneous tools to help them with their tasks, including paper notebooks, email systems, calendar applications, and in some cases, performance management systems. While these tools each offer some utility to the manager, they are not optimized for the task of people management, nor do they provide any synergy between themselves.

One aspect of the invention relates to a human resource management system which includes an objectives module or feature, a notes module or feature and an appraisal module of feature. The objectives module enables the periodic creation and storage of performance objectives for a plurality of employees. The notes module enables the periodic creation and storage of notes relating to the objectives. The notes are correlated with the objectives for view by the user. The appraisal module enables the periodic creation of performance appraisals for the employees. The appraisal module enables the user to selectively incorporate the objectives and selectively incorporate the notes correlated thereto into the appraisal. Consequently, performance appraisals can be produced which encompass the periodic collection of information relating to specific performance objectives, thus facilitating the generation of a high quality appraisal.

The system preferably includes an agenda module enabling the periodic creation and storage of agenda items between an employee and his or her manager. The agenda items are correlated with the objectives for view by the user. A given agenda item can be selectively converted into a note, which automatically inherits the objective associated with the agenda item. The agenda module, which is used to track current and upcoming issues for discussion, facilitates frequent interaction between managers and employees. The agenda module enables the results of such interactions and current issues to be logged as notes which form a basis for performance appraisal.

The preferred embodiment includes, in addition to the foregoing modules or features: personal profile & status, a calendar, an alert function. The preferred embodiment integrates and improves on the prior art by providing a single homogenous framework for the manager. A manager's day-to-day activities are supported, with individual employee agendas, status and calendar, and repositories for significant notes. Periodic activities are supported, with facilities for setting objectives and linking those to corporate objectives or to objectives up (or down) the management chain, and for appraising staff's performance against those objectives. An alert feature reminds the manager of upcoming events, overdue activities, and trends in employee behaviour which may warrant attention.

In the preferred embodiment, the objectives feature supports the agenda and notes features, by automatically creating “folders” associated with each objective, used by the agenda and notes features, advantageously facilitating organization of information, and simultaneously ensuring that objectives remain visible and not forgotten.

In the preferred embodiment, the agenda feature supports the notes feature, with automatic transposition of selected agenda items to the correct file of notes for the relevant employee; this further increases the likelihood of notes being kept, which increases the quality of eventual appraisals.

In the preferred embodiment, the objectives feature supports the appraisal feature, with automatic structuring of an appraisal based on the performance objectives, insuring that performance objectives are not ignored at the time of an appraisal.

In the preferred embodiment, the notes feature supports the appraisal feature, by permitting the manager to tag notes (e.g. as “praise” or “criticism”, or with some other assessment-based tag), allowing for the sorting of notes by these tags, and the selection and automatic inclusion of selected notes into an appraisal.

In the preferred embodiment, the calendar feature supports the status feature and the directory, providing the manager an automatically generated view of all their staff's status (e.g., on vacation, in the office, on client site, etc.), and the organization as a whole to see an automatically generated directory showing status and telephone numbers for that specific day.

In a preferred embodiment, the alert feature integrates with the calendar feature, providing automatic warnings for upcoming employee vacations, overdue employee vacations, and unacceptable patterns of absence.

In a preferred embodiment, the alert feature integrates with the notes feature, providing automatic warnings if notes are not kept, or if certain tags are being under- or over-used (e.g. if unacceptable levels of “criticism” notes are kept).

In a preferred embodiment, the alert feature integrates with the objectives feature, providing automatic warnings if objectives are not kept up to date, or if specific target objective completion dates are not met.

In a preferred embodiment, the alert feature integrates with the appraisals feature, providing automatic warnings if appraisals are not kept up to date.

In a preferred embodiment, the close integration of day-to-day features with periodic features provides additional advantages by allowing the periodic tasks to become a simple extension of day-to-day tasks, eliminating user confusion and learning curves associated with rarely-used tools.

Advantageously, the preferred embodiment enables:

collaboration, allowing a manager to share portions of employee data to facilitate enhanced communication and productivity.

specialized alerting, advising or reminding manager of specific future events (e.g. preprogrammed dates), dynamically determined future events (e.g. an employee vacation), advising of system events which do not occur (e.g. desirable periodic events such as note taking, praise, vacation), advising of system events which exceed specified thresholds (e.g. a significant number of absences in a specified period).

specialized reporting, allowing an organization to determine the effectiveness of its managers.

a calendar status addition to a directory which is responsive to the organizational structure of an organization to allow employees' data to be visible to their supervisors at all levels.

tags to be associated with journal entries, with quick access to specific tagged entries, thus accelerating the compilation of specifically tagged entries into such documents as an employee appraisal.

### BRIEF DESCRIPTION OF THE DRAWINGS

FIG. 1a illustrates an example embodiment of the invention in which users from a variety of organizations use the invention by way of a common server on the internet.

FIG. 1b illustrates an example embodiment of the invention in which users from a single organization use the invention by way of a common server on the organization's intranet.

FIG. 2 illustrates an example of an organization, and is provided to facilitate detailed explanations of use of the invention.

FIG. 3 (all parts) illustrates example user interface screen layouts of one possible user interface design for the invention, representing use by someone acting in a managerial role.

FIG. 4 (all parts) illustrates example user interface screen layouts of one possible user interface design for the invention, representing use by someone acting in an employee role.

FIG. 5 (all parts) illustrates example data structures supporting the implementation of the invention.

FIG. 6 (all parts) illustrates logical flow of the invention.

FIG. 7 (all parts) illustrates example user interface screen layouts of the directory function of the invention.

FIG. 8 (all parts) illustrates example report output of the invention.

### DETAILED DESCRIPTION OF THE INVENTION

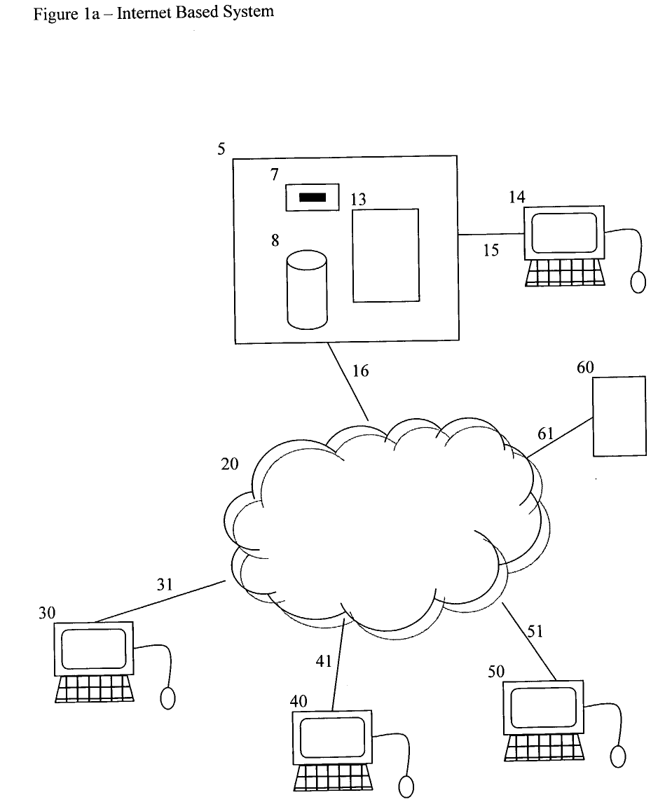

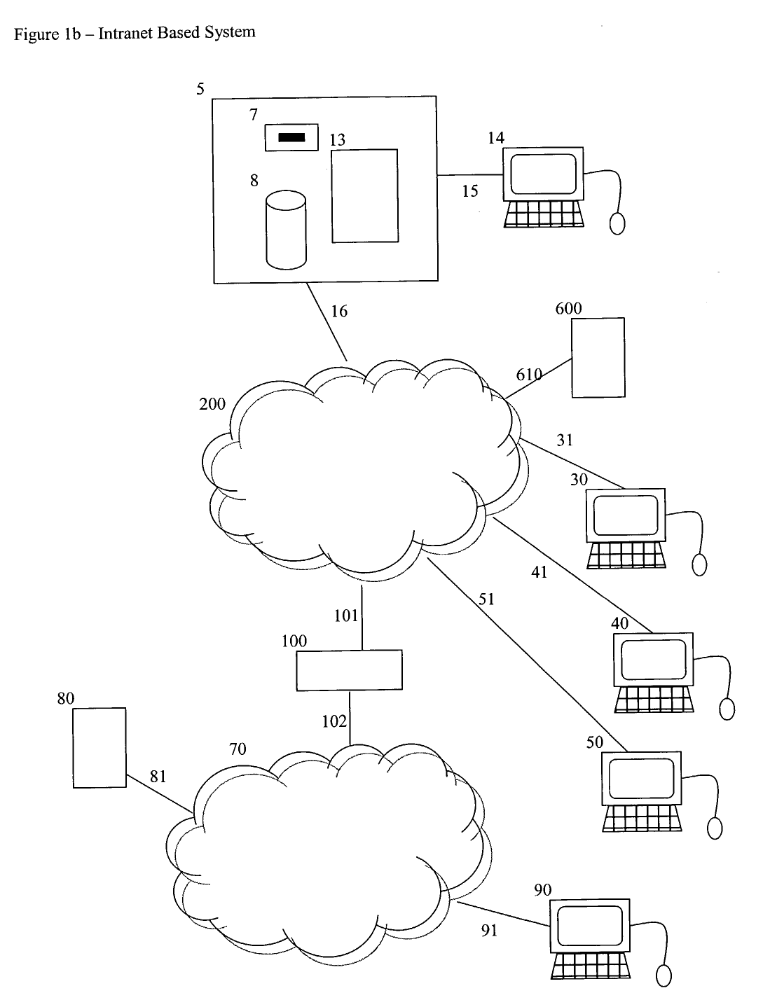

FIG. 1a illustrates an internet-based variant of the invention, particularly suited to support large numbers of users from different organizations. An application server 5 comprised of data reader for CD or diskette or the like 7, data storage device such as hard disk 8, operating system (not shown), application software (not shown) and CPU 13, is connected to the internet 20 via link 16. Preferably, the operating system will support the use of the application server by multiple users at the same time. An administrative terminal 14 is connected to the application server 5 via link 15. User terminals 30, 40, and 50 are connected to the internet via links 31, 41, and 51 respectively, and would normally be comprised of a typical personal computer, with display, keyboard, mouse, CPU, and network interface. The details of application server hardware architecture, internet architecture, administrative and user terminals architecture, and link architecture are not specific to the invention and many existing alternatives are well known to those skilled in the art.

It is well known in the art that an application server 5 can be advantageously spread across multiple CPUs, to increase the capacity, speed and redundancy of the system.

It is also well known in the art that an application server 5 can be “mirrored” to one or more additional locations, to increase the capacity, speed, and redundancy of the system.

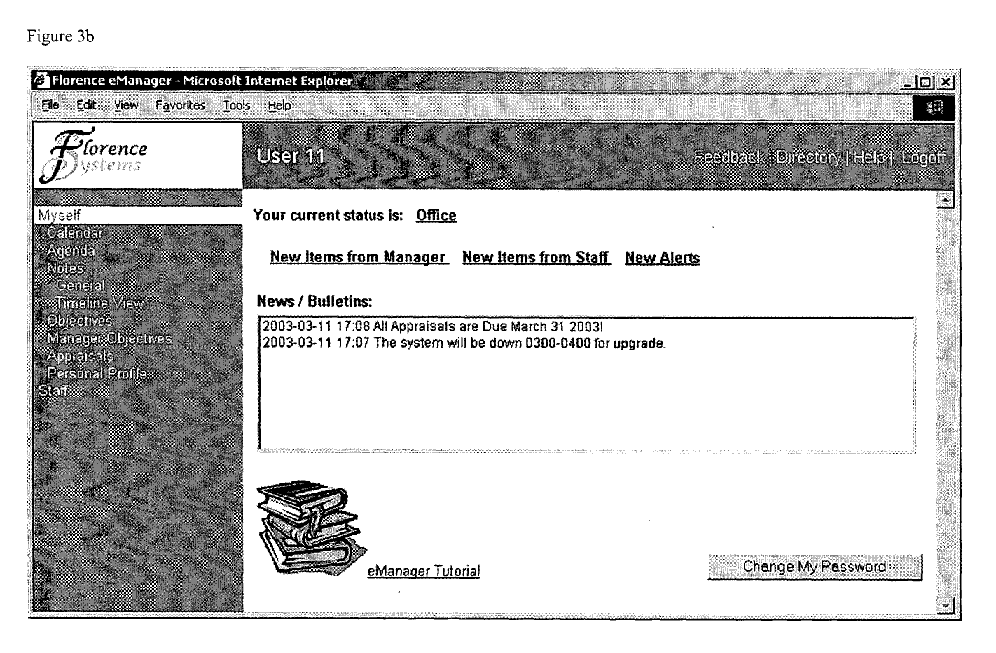

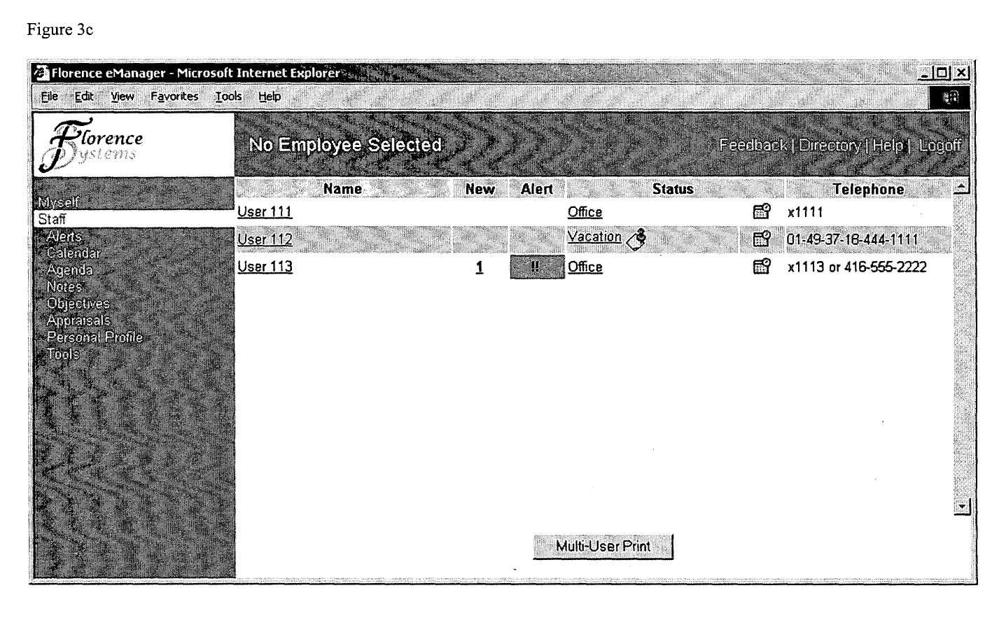

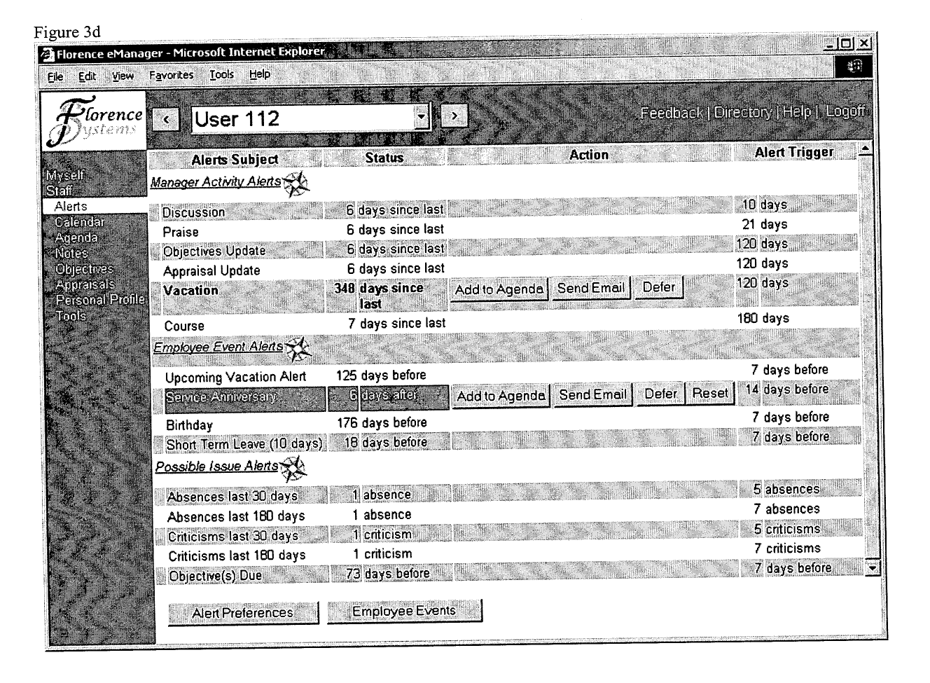

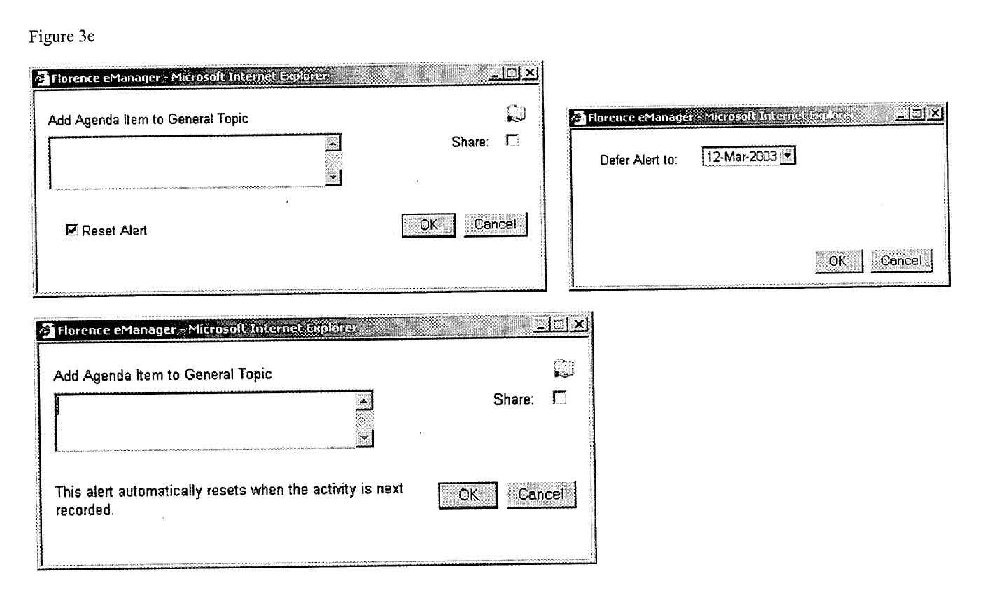

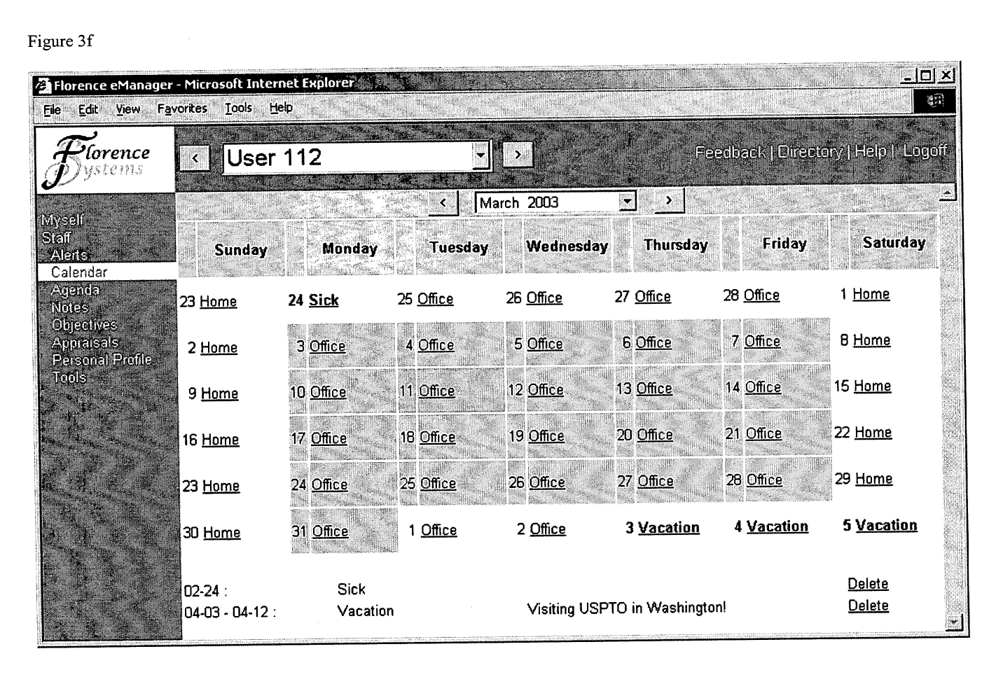

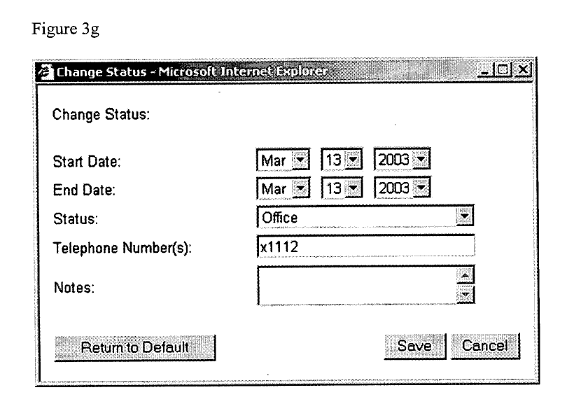

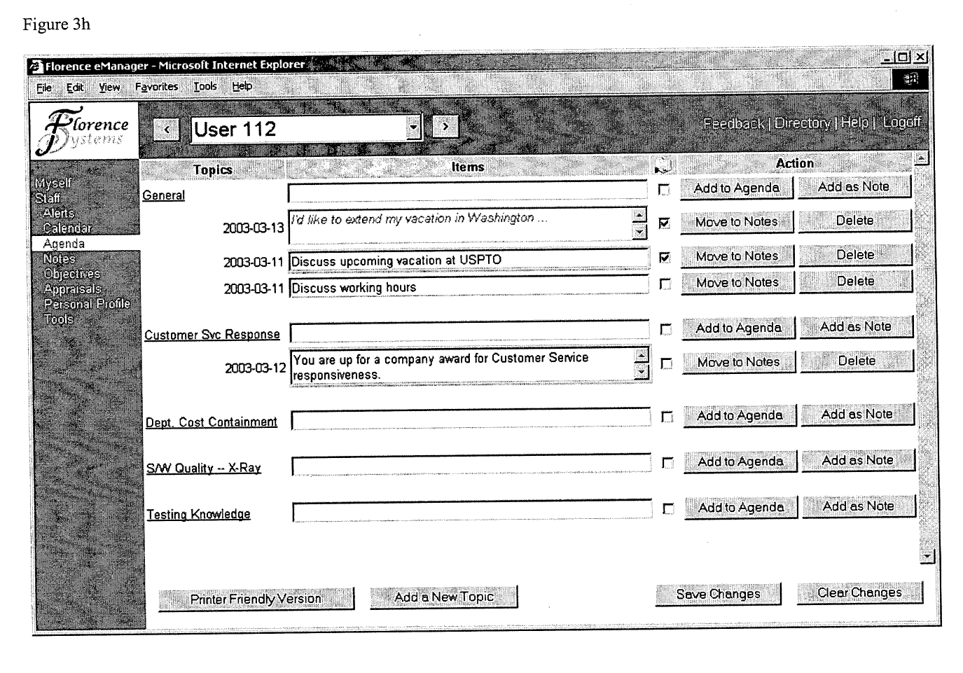

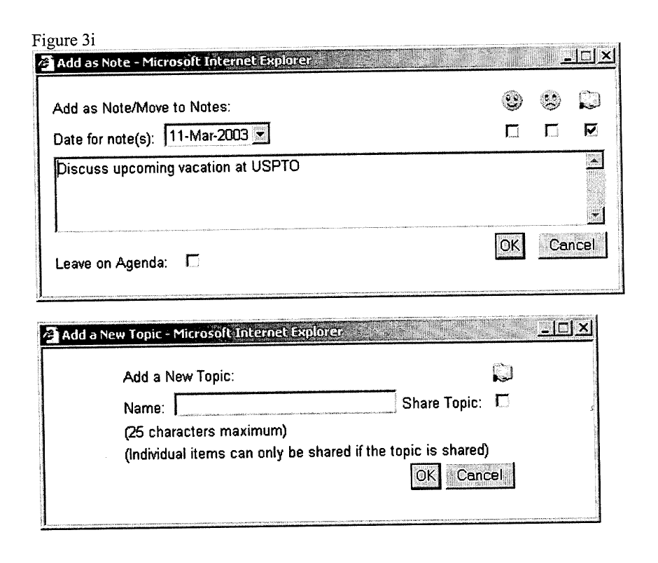

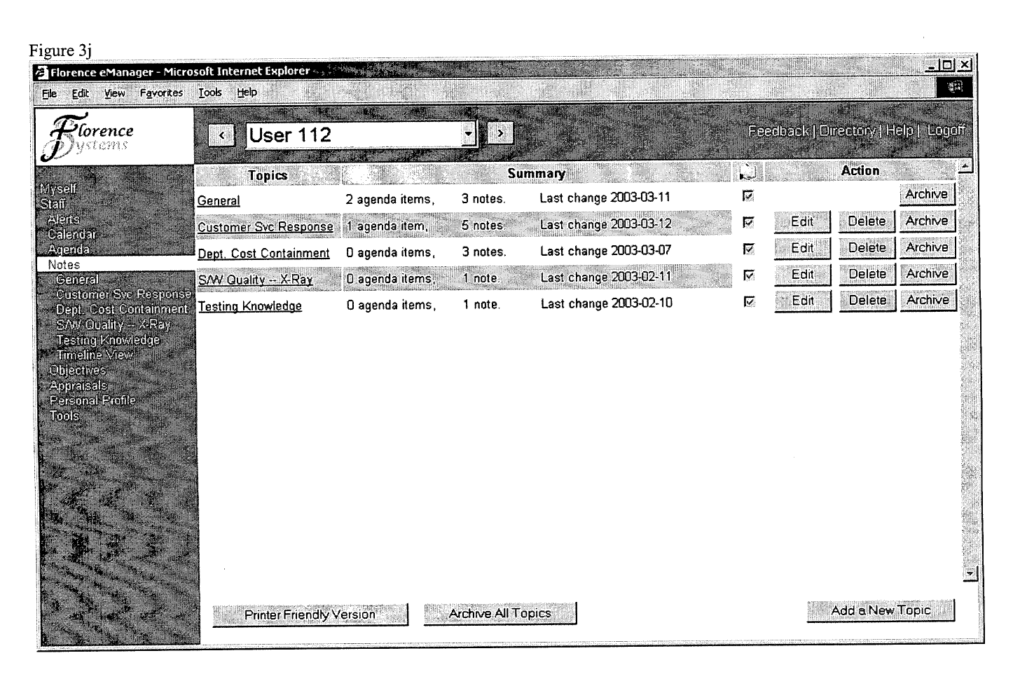

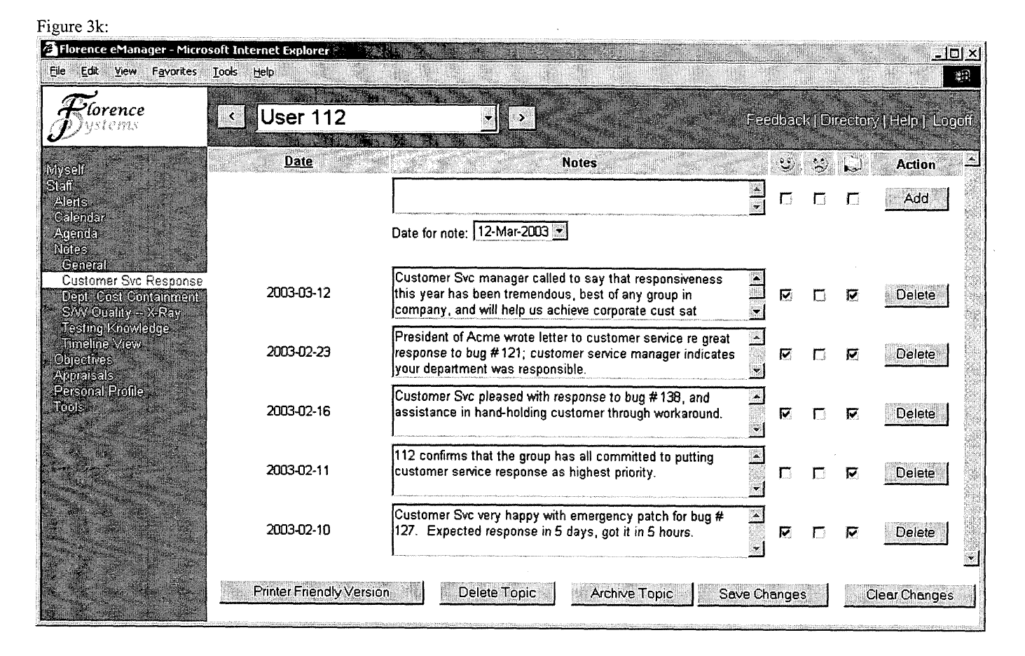

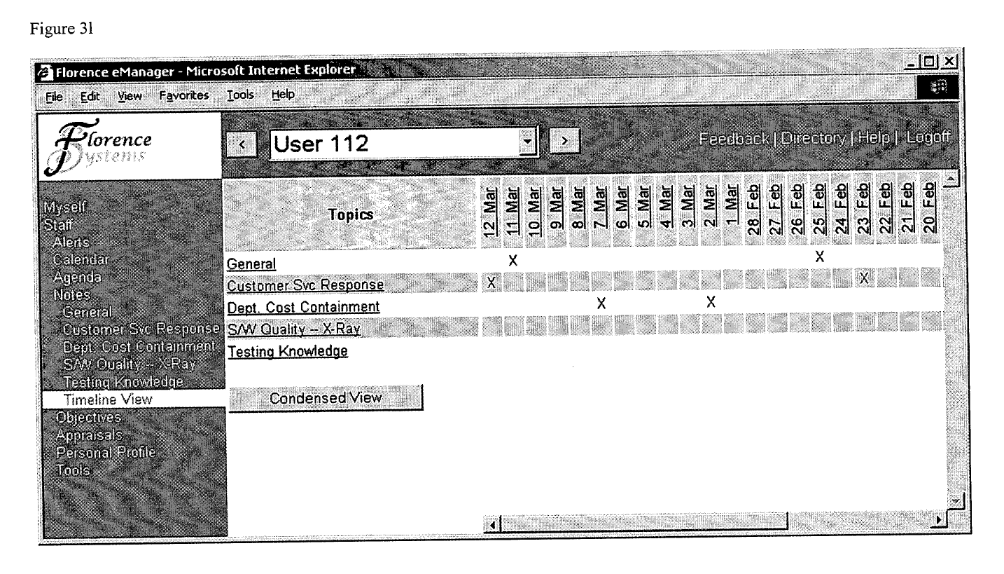

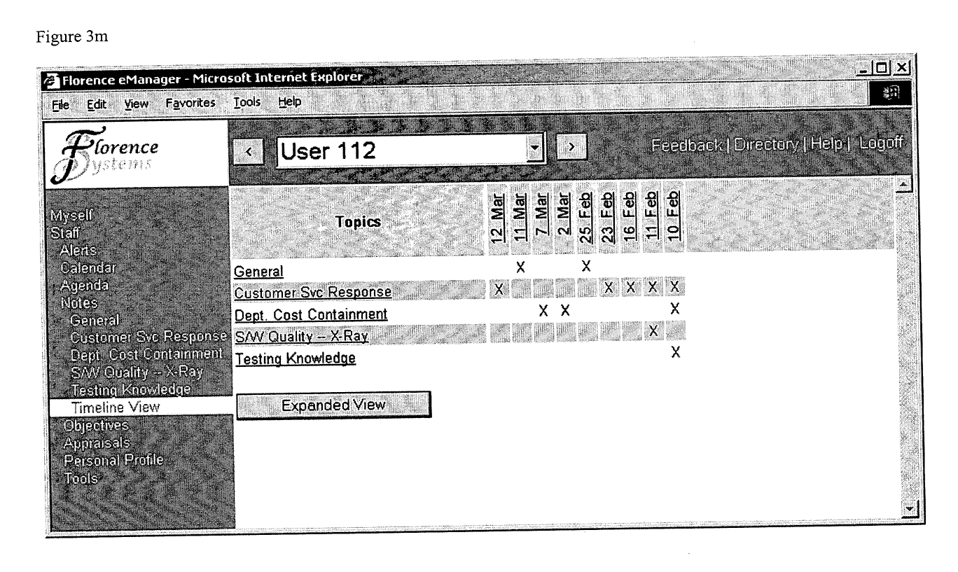

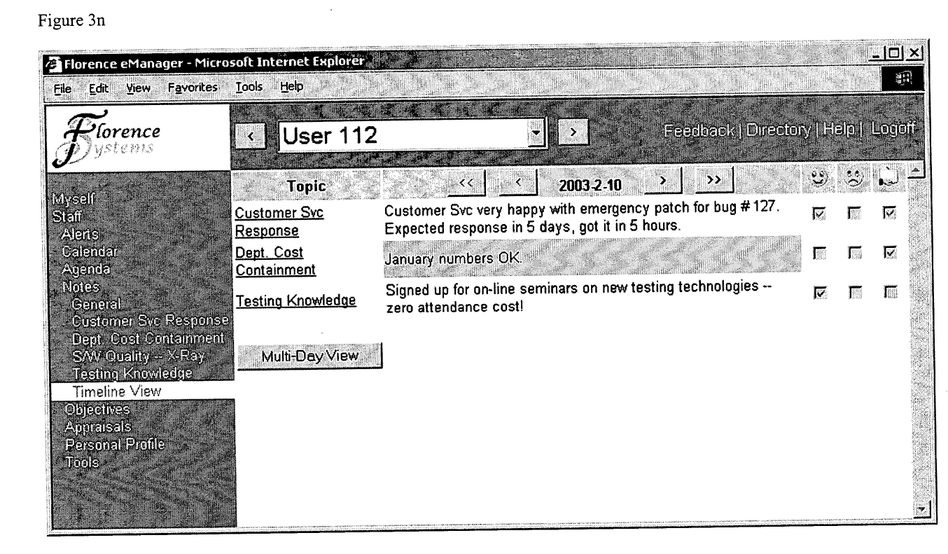

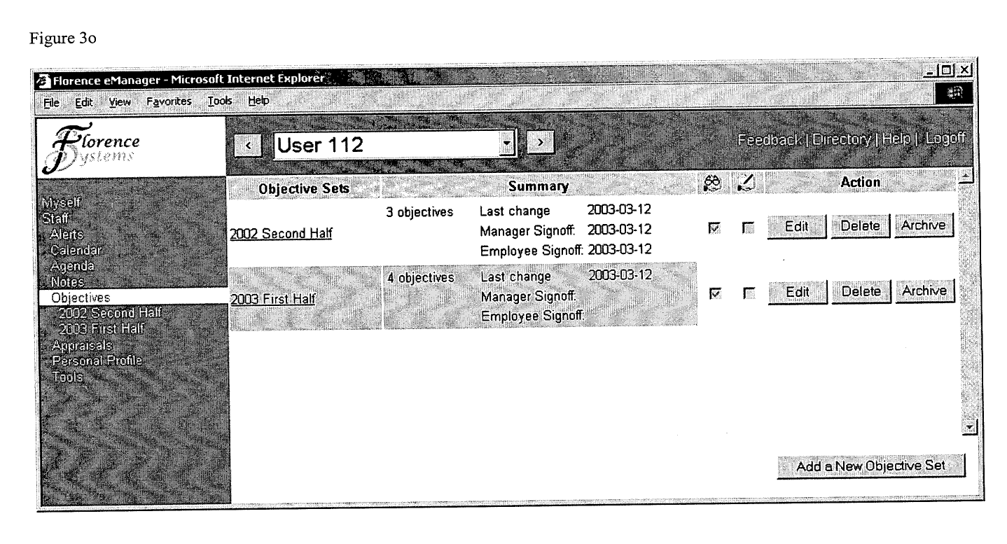

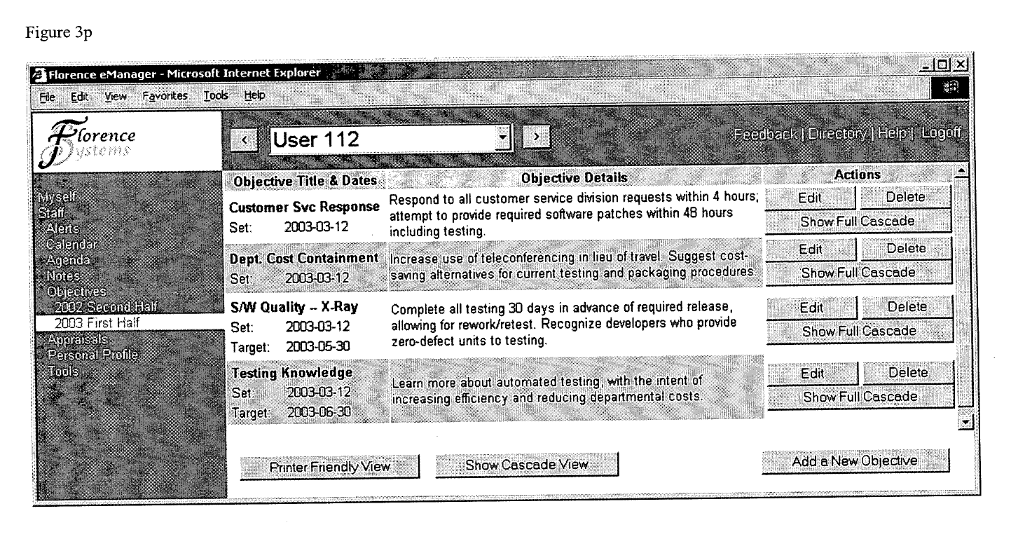

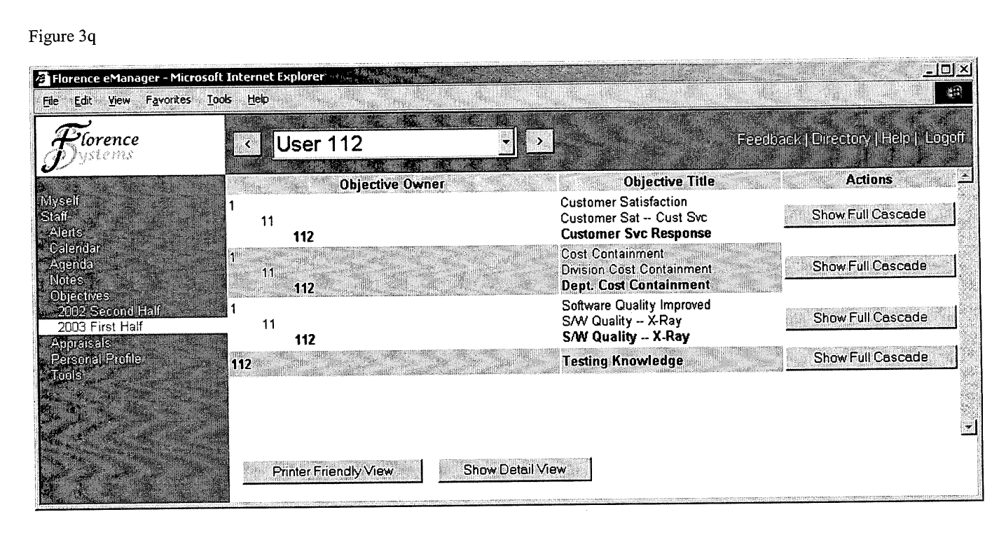

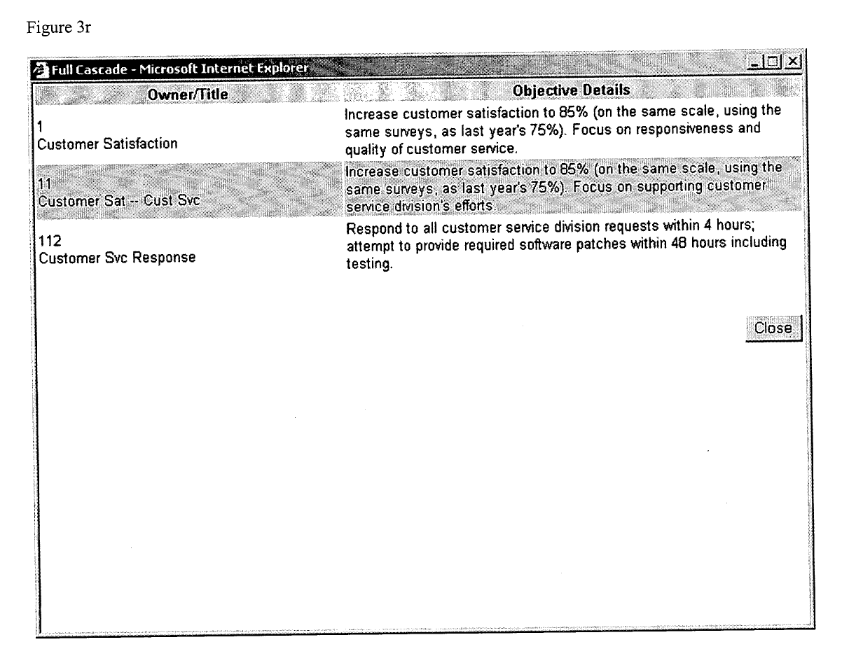

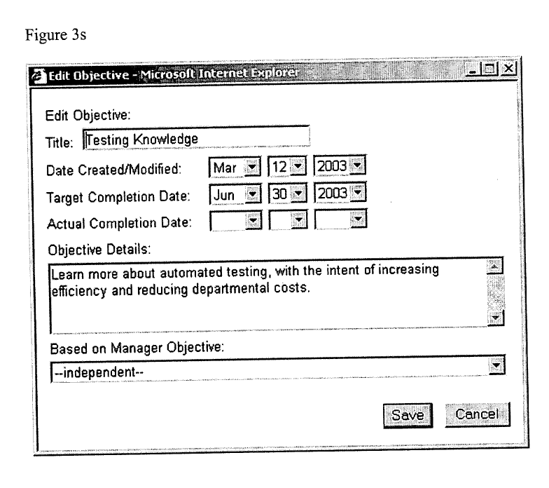

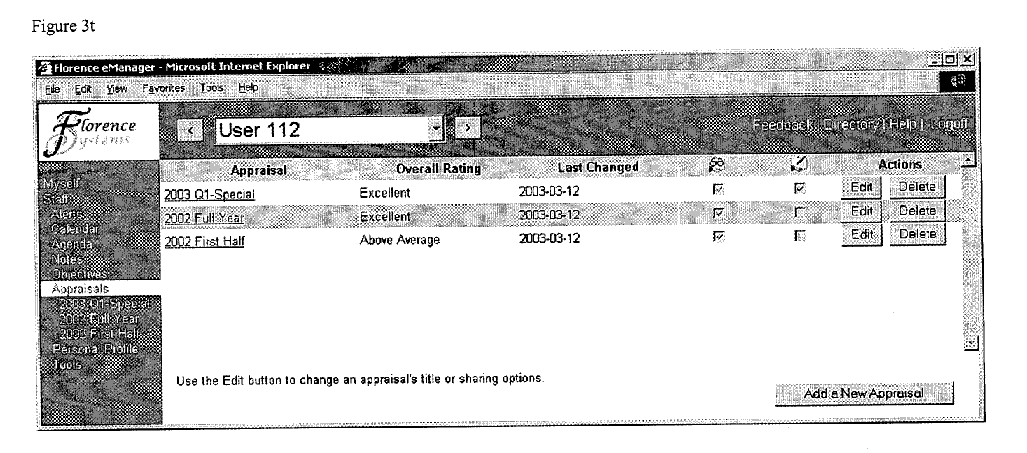

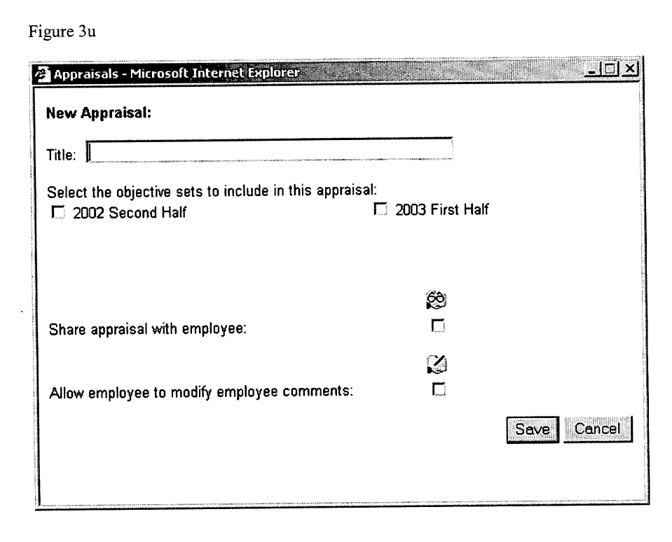

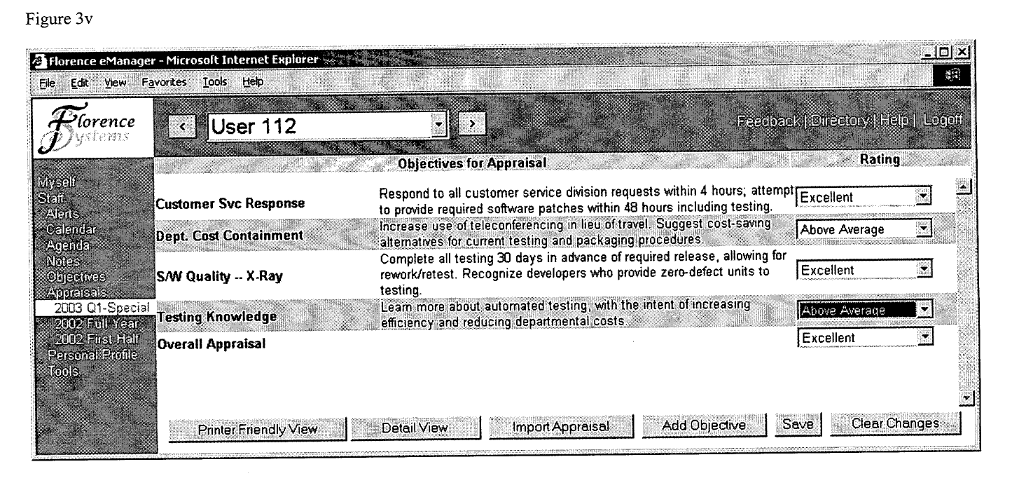

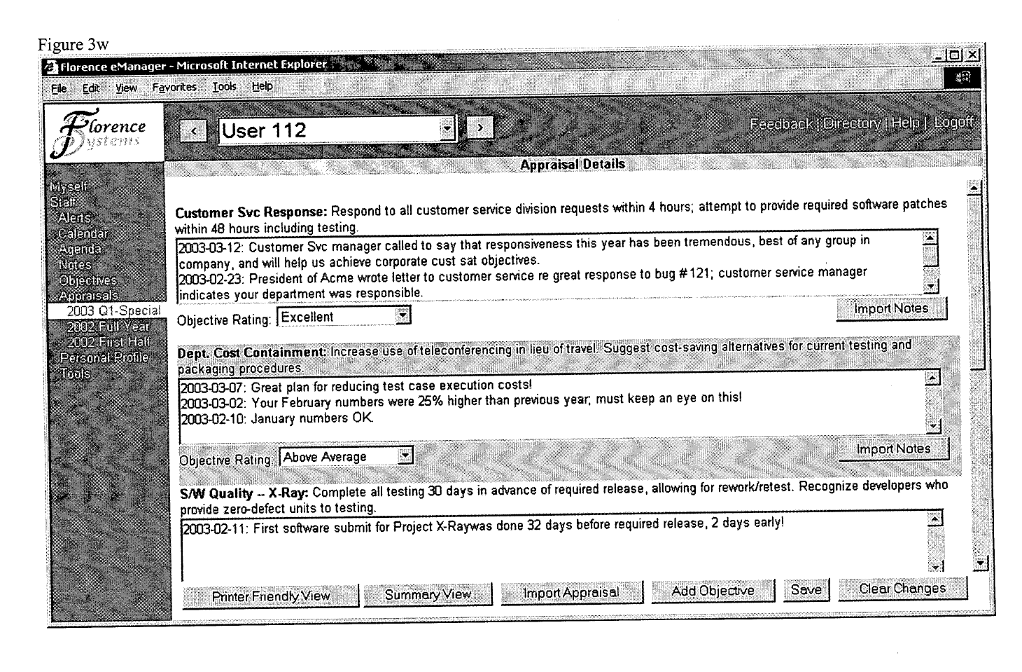

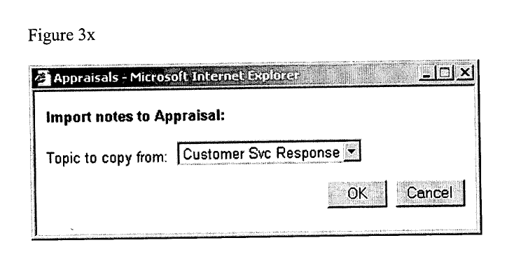

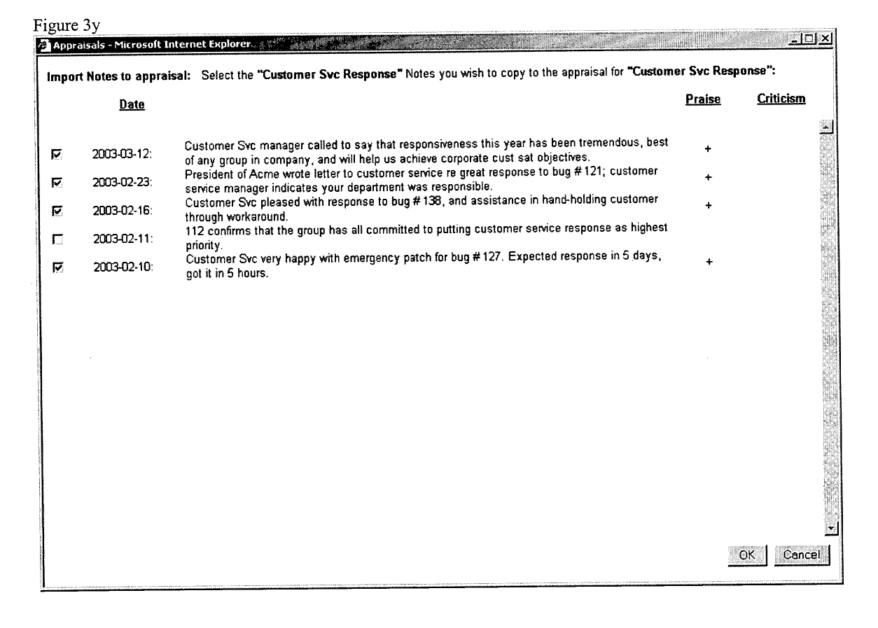

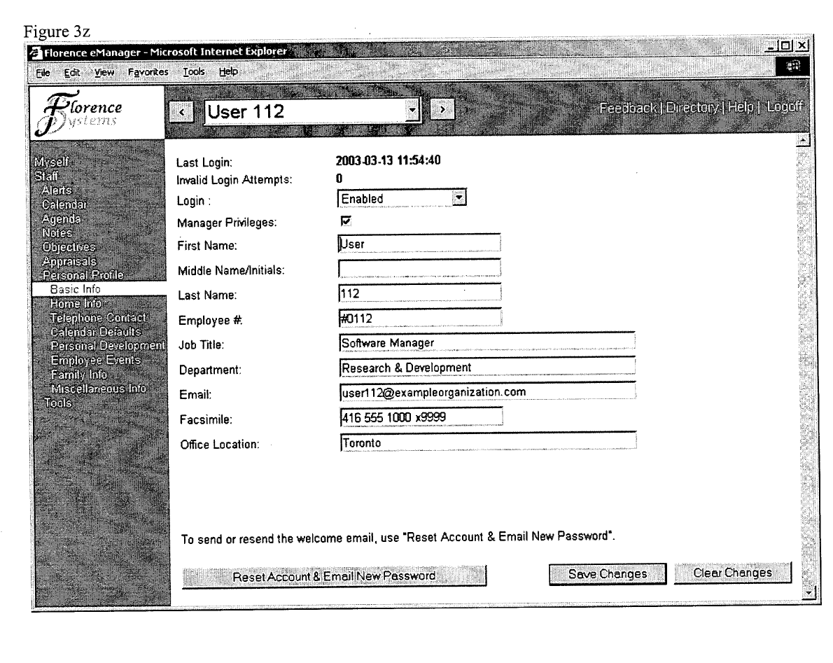

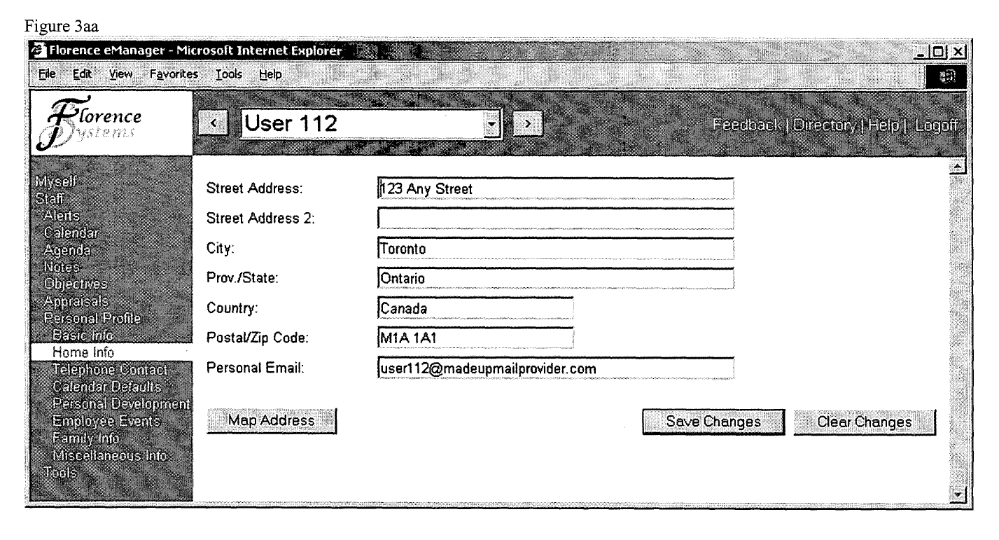

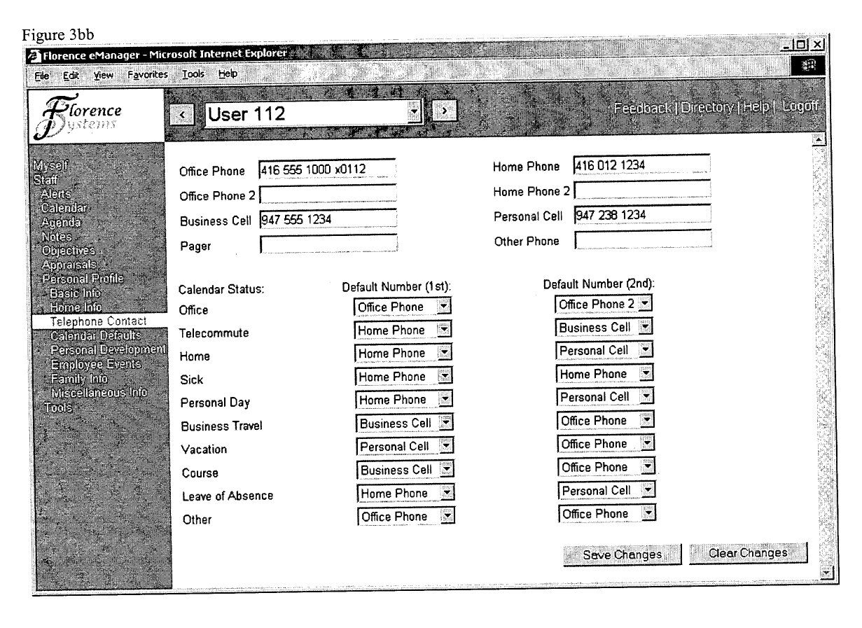

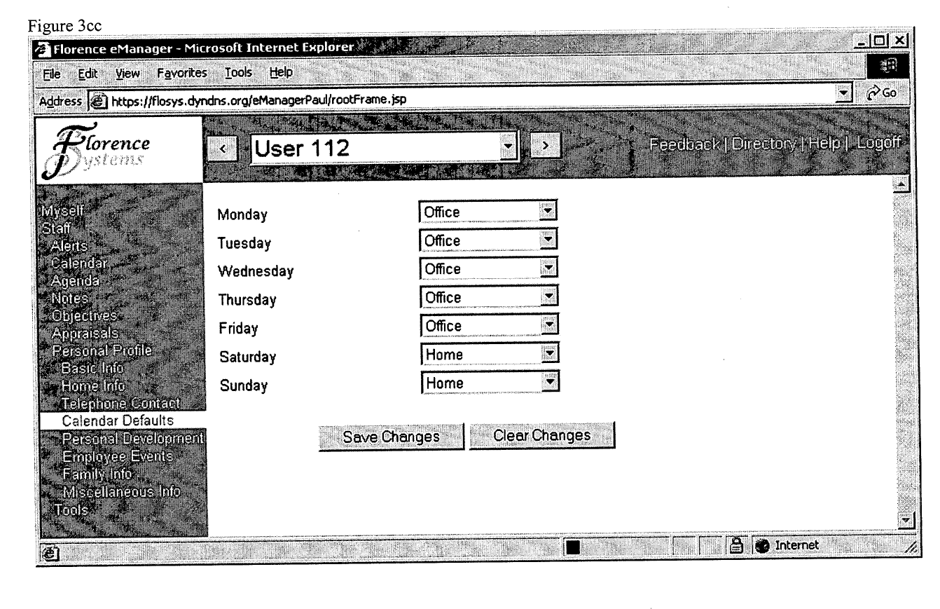

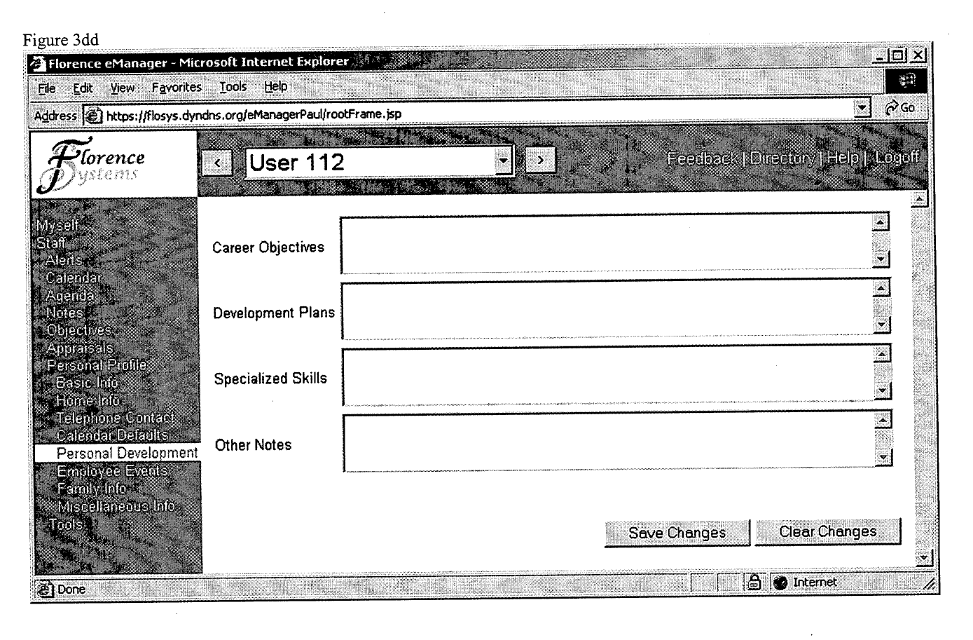

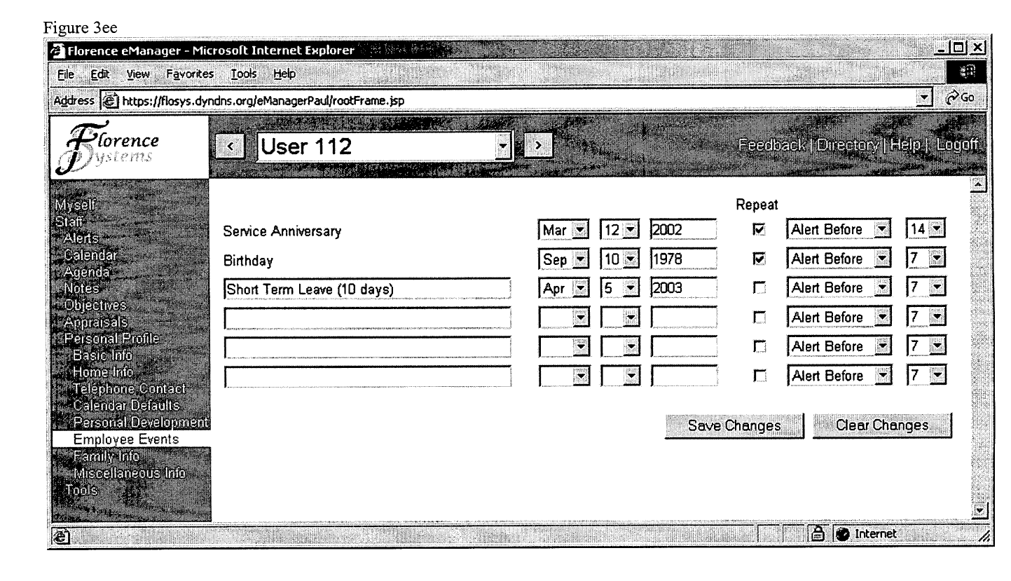

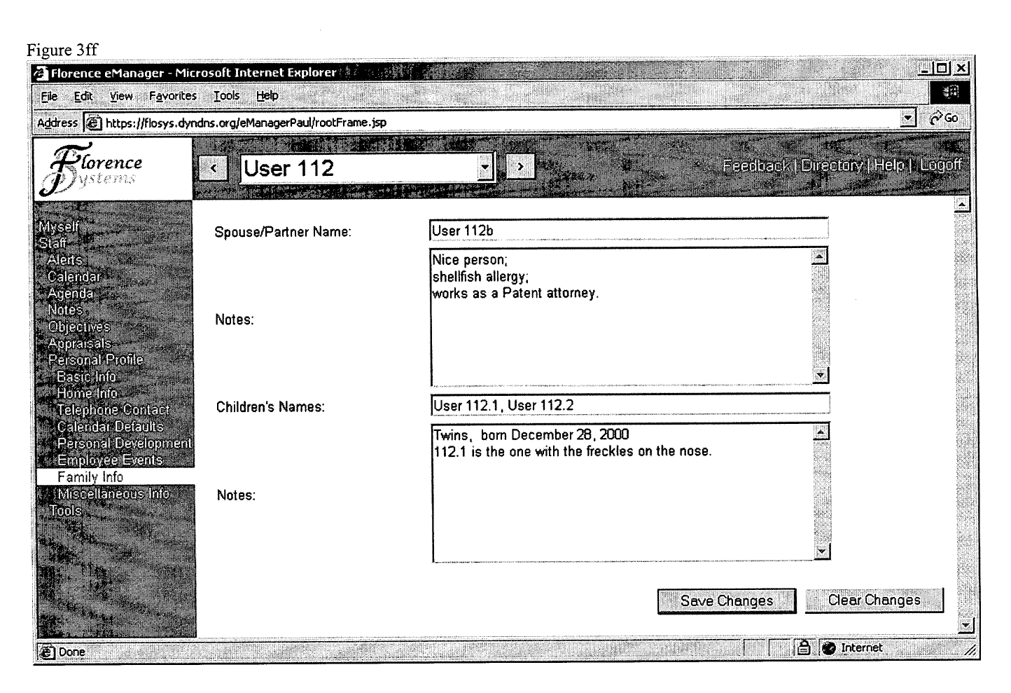

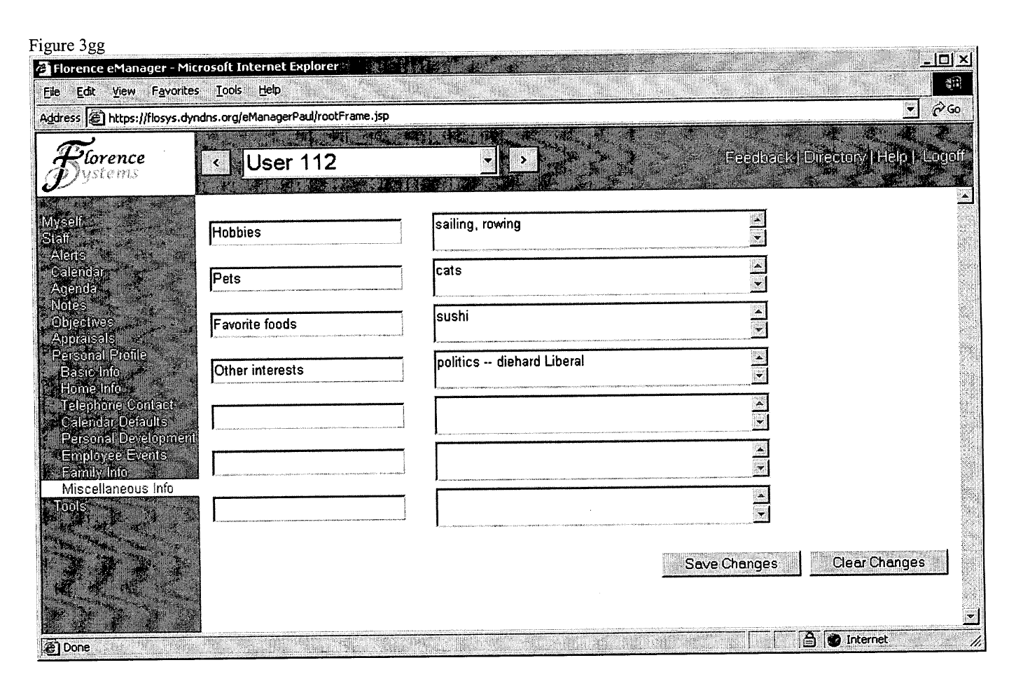

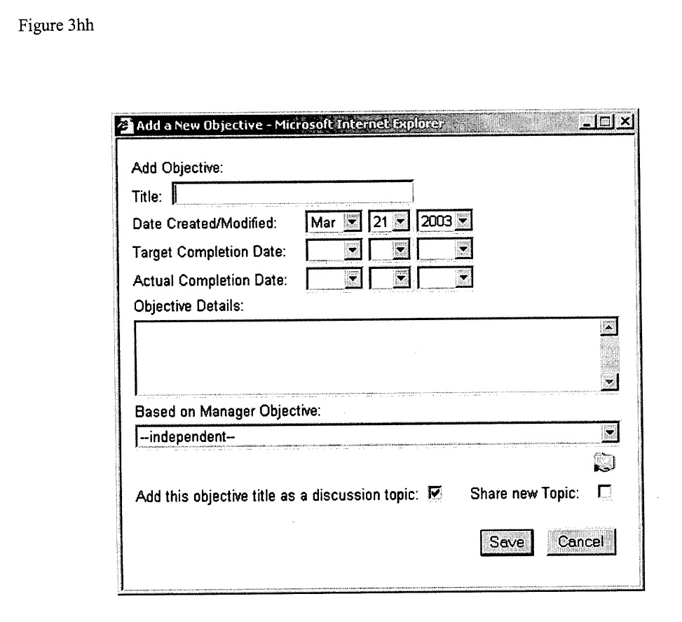

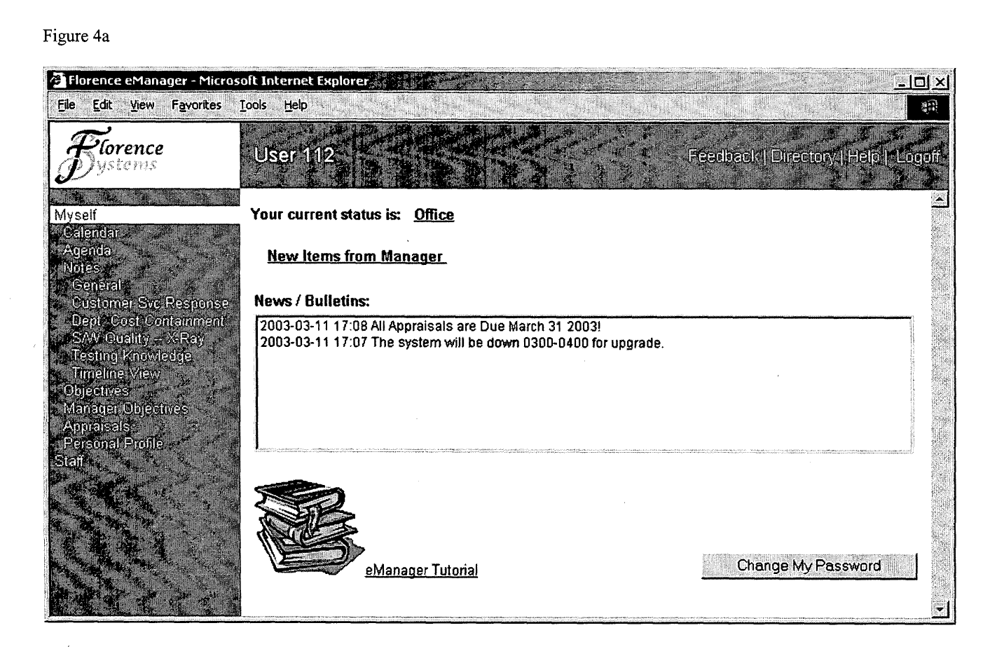

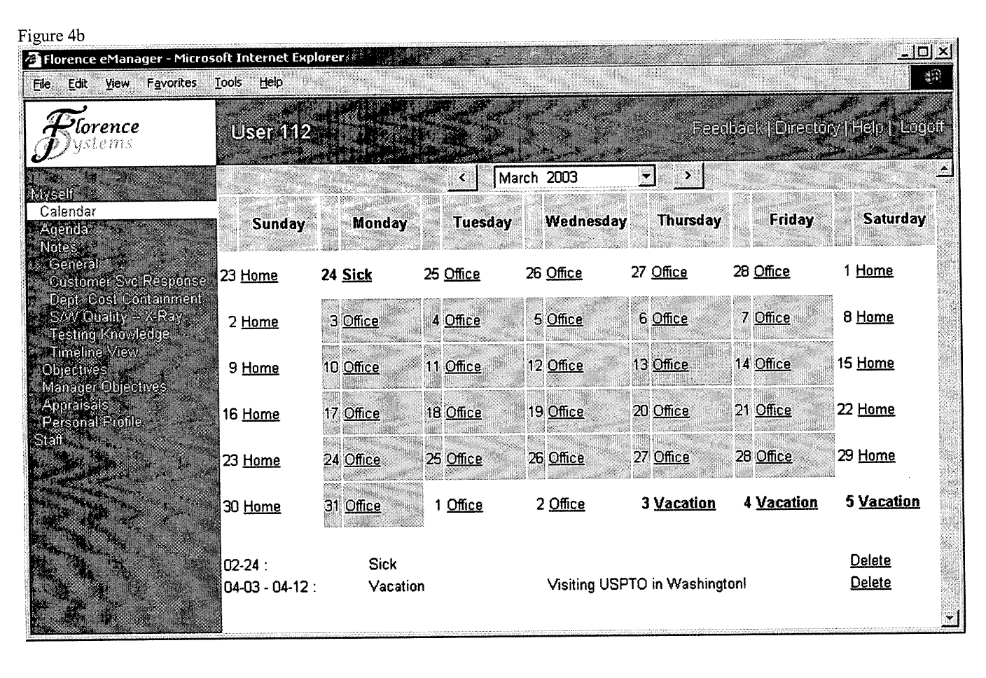

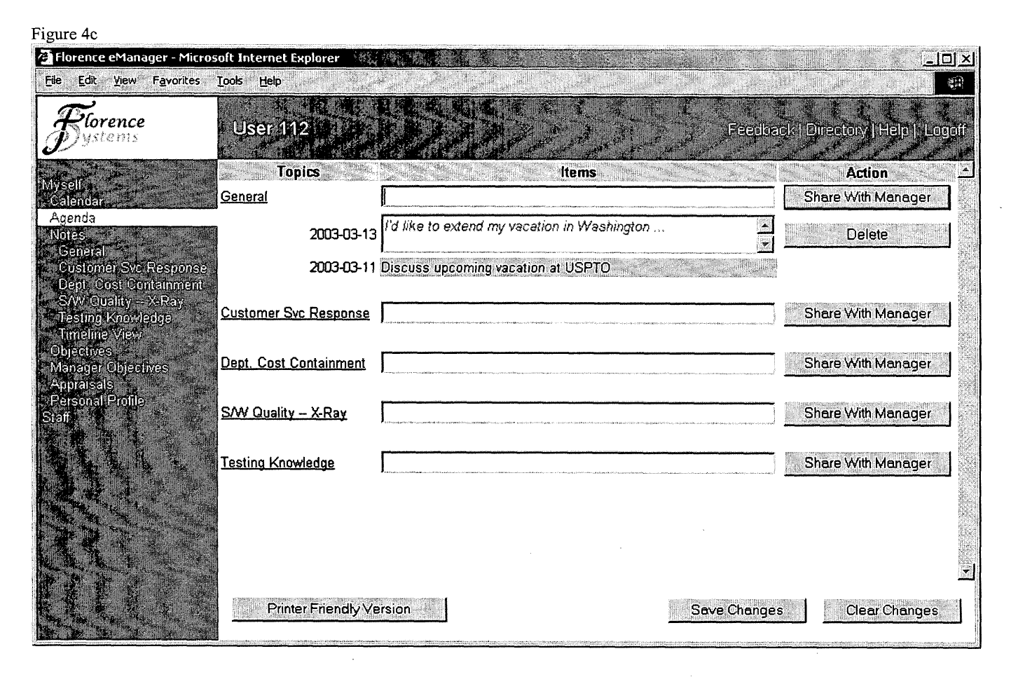

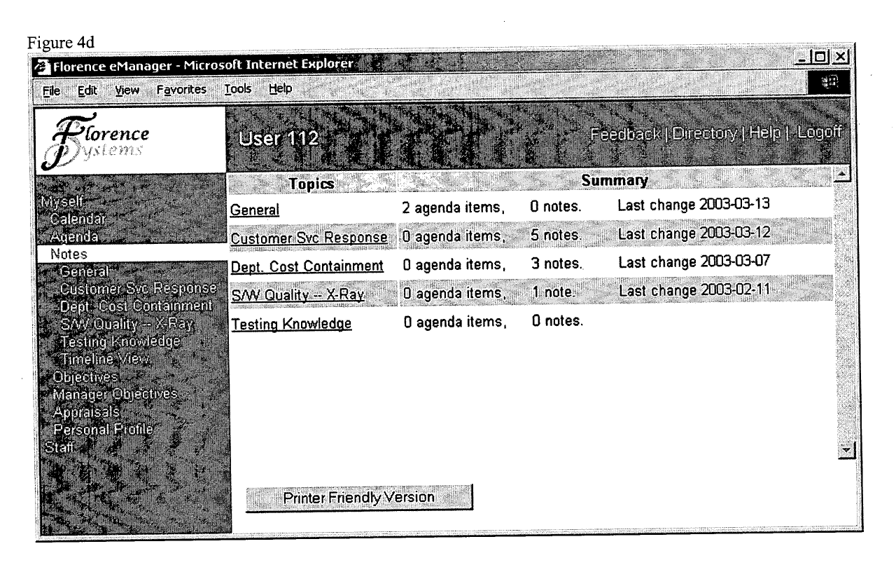

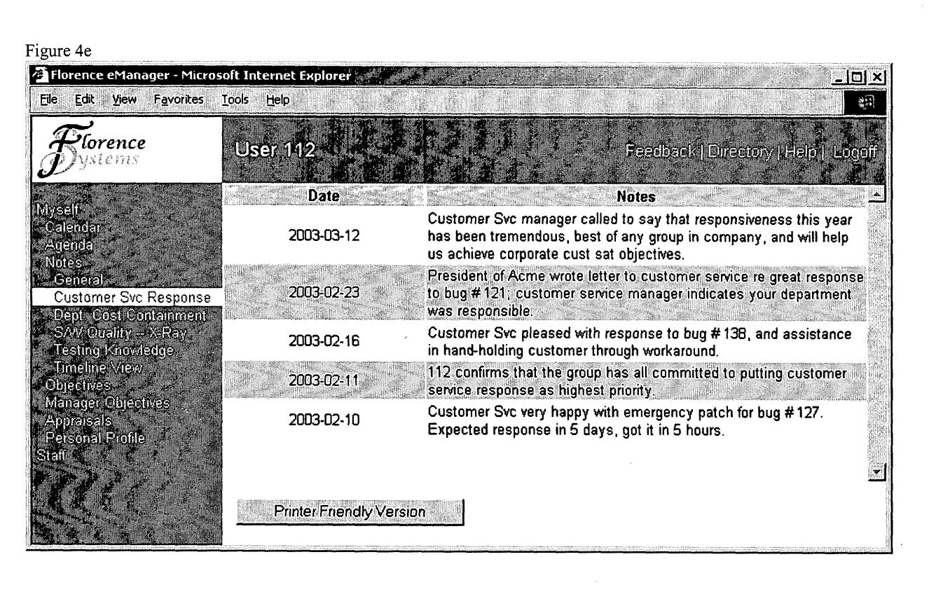

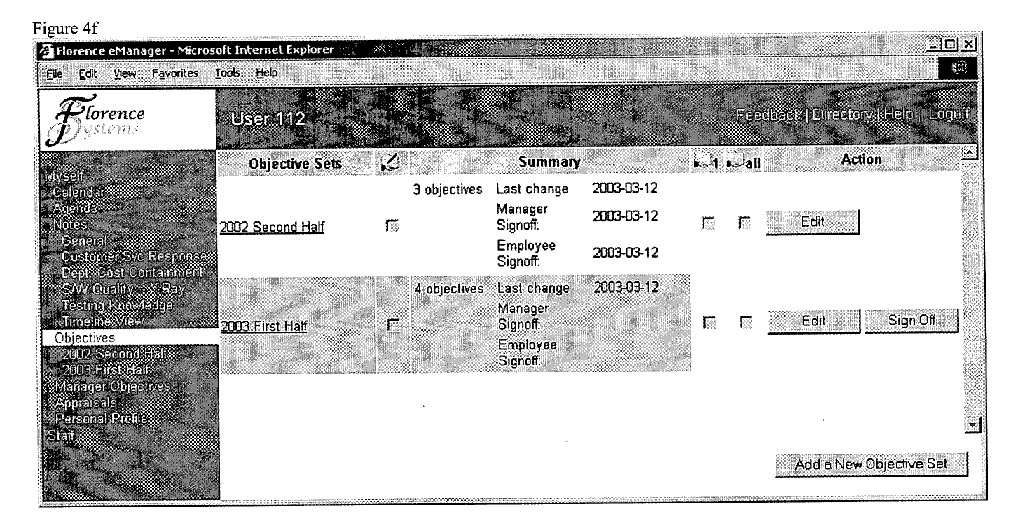

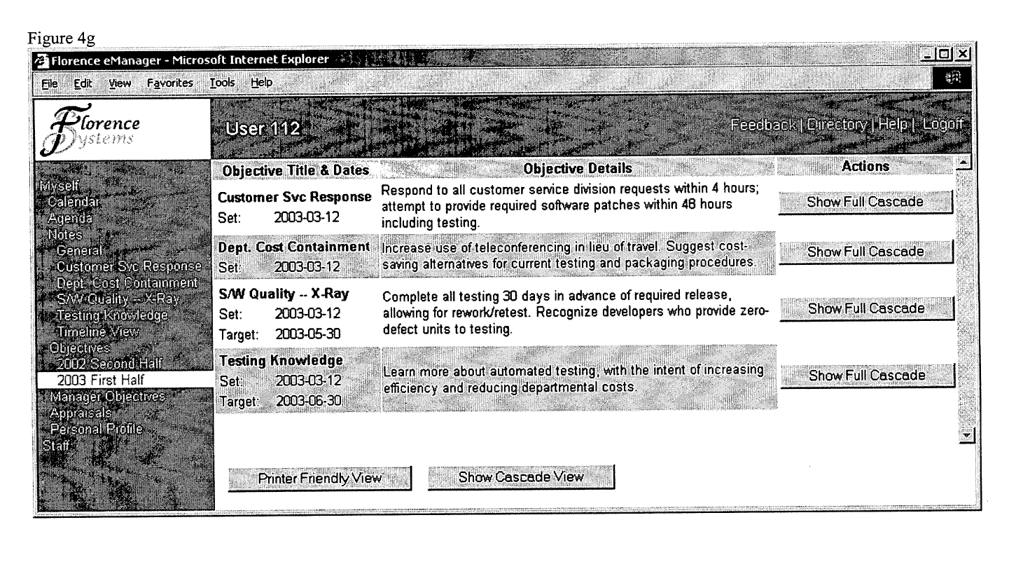

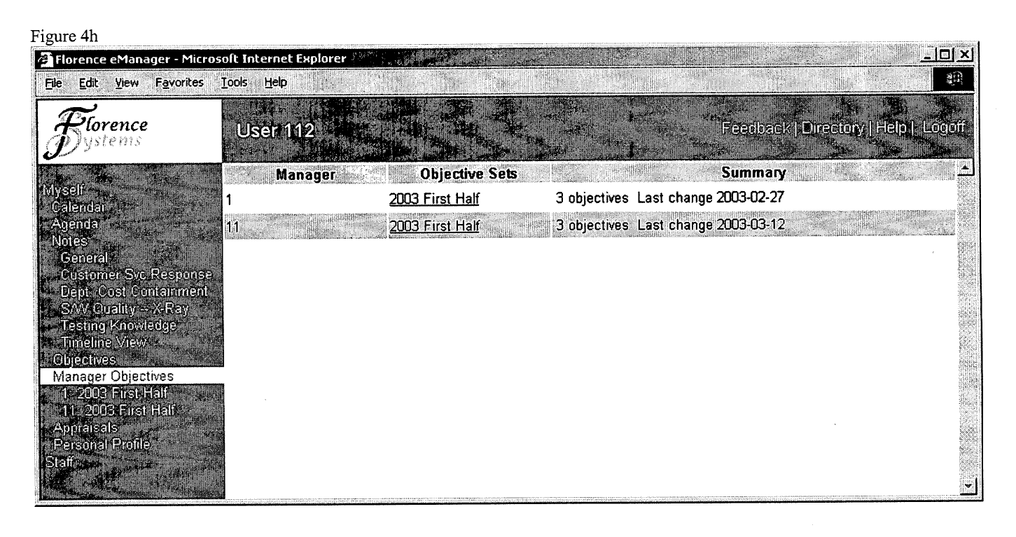

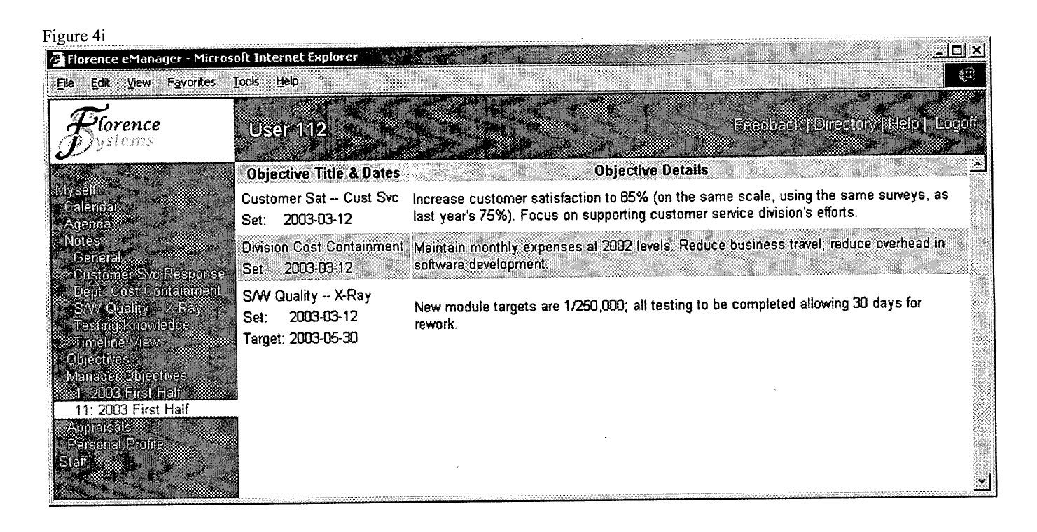

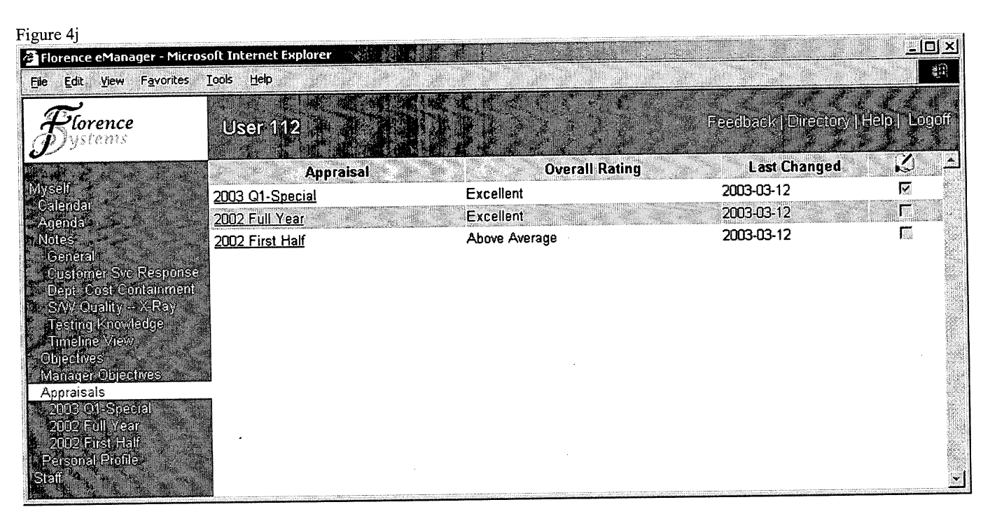

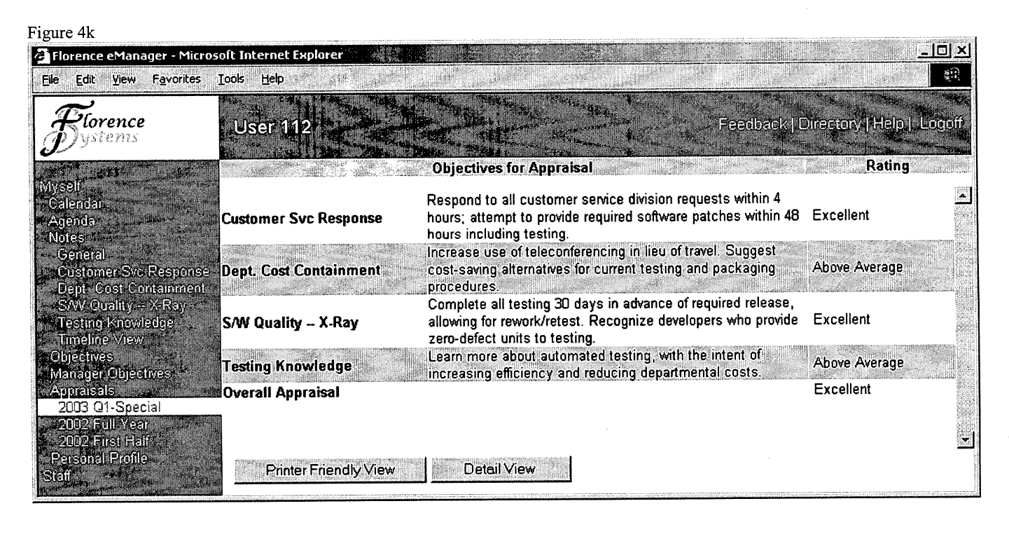

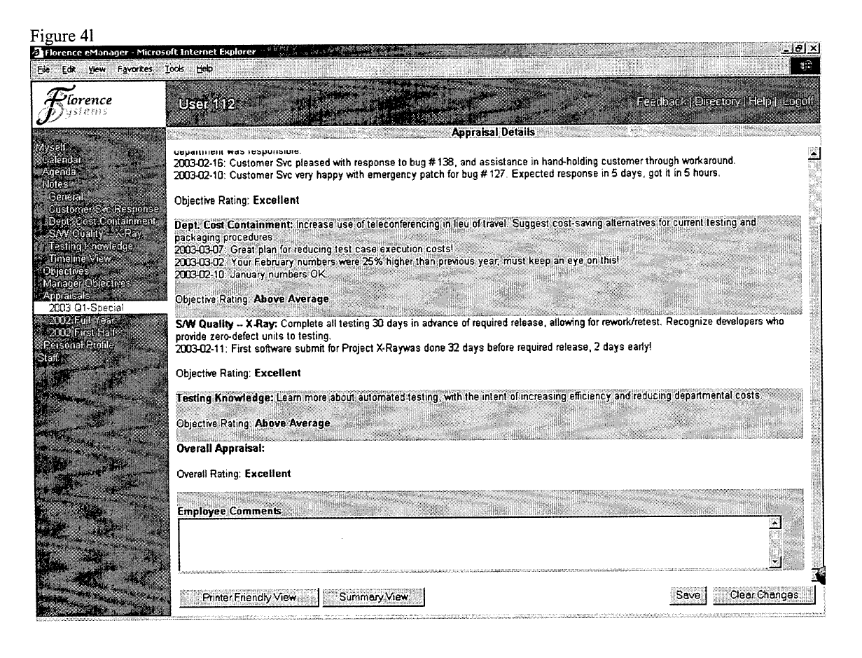

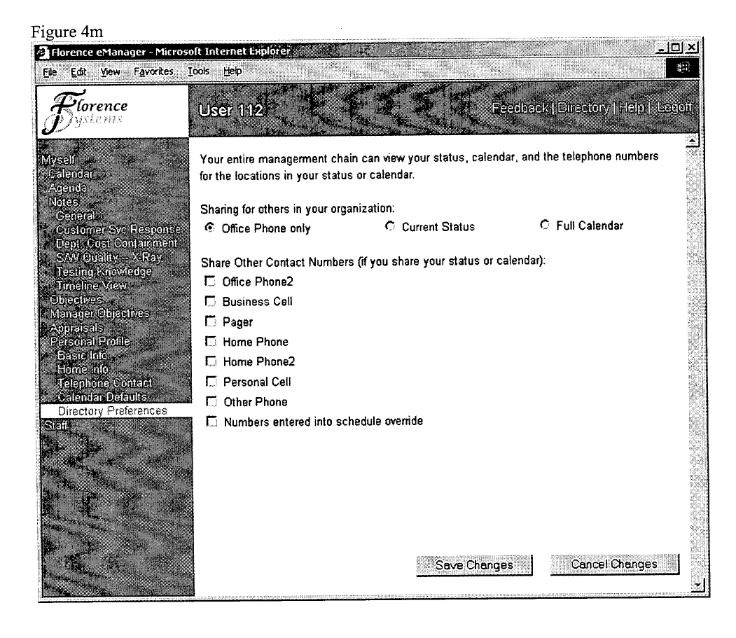

In typical use, a user at terminal 30 would access the application through a browser application such as Microsoft™'s Internet ExplorerÔ or Netscape™'s NavigatorÔ. The user would provide the browser application with a network address, which would cause a request to be made through the internet to locate the required application server 5. The CPU 13, under control of the application software and operating system would cause appropriate HTML and other internet standard protocol codes to be sent via the TCP IP protocol or another internet standard protocol back to the user, presenting the user with a user interface as exemplified in FIG. 3 or FIG. 4, depending on whether the user is acting in a managerial role, or an employee role.

The user interface would cause the user to log in (either explicitly, or implicitly through such techniques as internet “cookies”) and then provide the user with access to their data, with the methods provided by the invention.

Simultaneously additional users at terminals 40 and 50 may also be accessing data at the server, supported by the server's use of the operating system.

Some aspects of the invention provide third party information to the user; in this case a request from user at terminal 30 may be handled by application server 5, which in turn may request data from a third party server 60 (which is connected to the internet through link 61), and then forward that data back to the user terminal 30 with or without modification.

While typical use would be through a network browser, it can be appreciated that a client-server architecture may also be a beneficial model, in which case the terminal 30 would be provided and would maintain a client software (not shown) for execution on that local terminal's CPU (not shown), and that client software would exchange data with the application server 5, eliminating the need for the transmission of user interface details. The client software can provide a similar user interface to that described in FIG. 3 (all parts).

It should be recognized that while user terminals are illustrated as PCs in FIGS. 1a and 1b, a full range of other user terminal devices (PDAs, tablet PCs, palm-top PCs, micro-browser equipped telephones, etc.) can be beneficially used within this architecture to access the features of the invention (necessary gateways are simply added to the network backbone). The recasting and segmenting of an application's user interface for access on such devices is well within the knowledge of those skilled in the art, and indeed, may be done automatically by existing tools and software applications, and as such is not described further herein. It may be desirable to offer a user interface with limited features (and not all of the features of this invention) on a user terminal device with limited computing power, such as a PDA.

FIG. 1b illustrates an intranet based implementation of the invention. In this implementation a single organization of sufficient size would have an application server 5 which is located internally to the company, connected to local network 200, serving users at user terminals 30, 40 and 50. Some advantages of this arrangement are that the application server (5) is the property of the organization, and all data is maintained within the organization's internal network. The application server (5) may request data from an internal server 600 (which is connected to the intranet through a link 610) and then forward that data back to the user terminal 30 with or without modification.

This implementation may also provide access to third party data servers 80 on the internet 70, through a gateway 100 between the internal network 200 and the internet 70. Support for organization users remote to the local network 200, but connected to the internet 70, can also be provided through the same gateway 100, by means of a user terminal 90 connected to the internet 70 by a link 91.

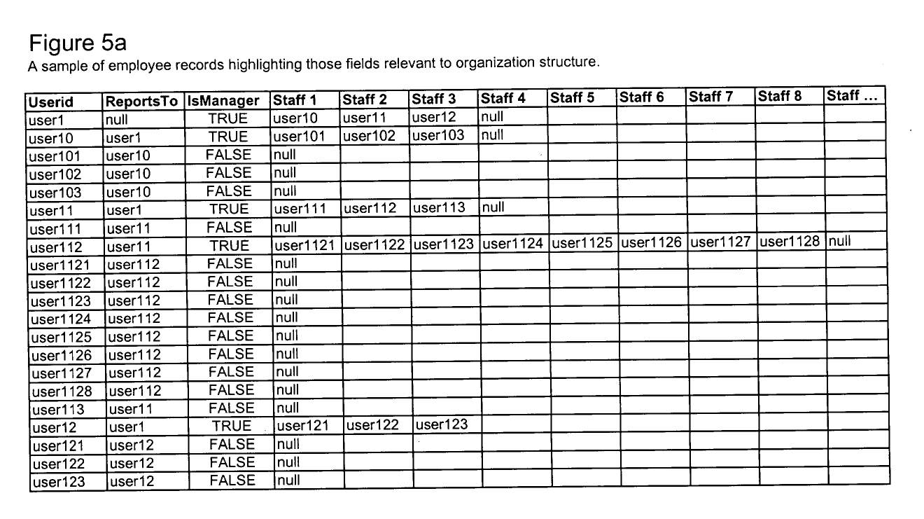

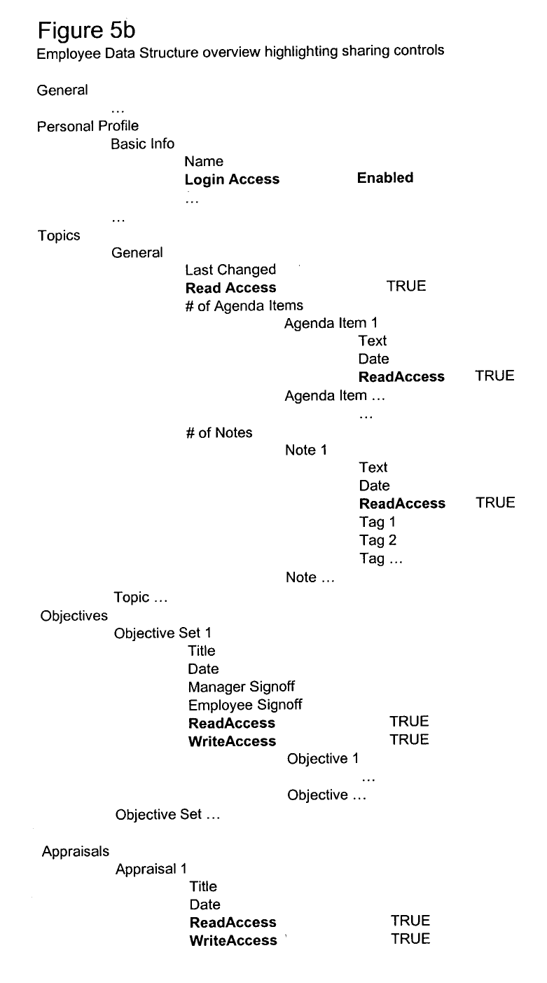

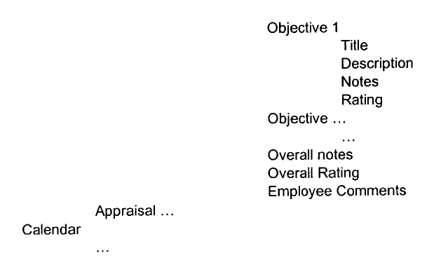

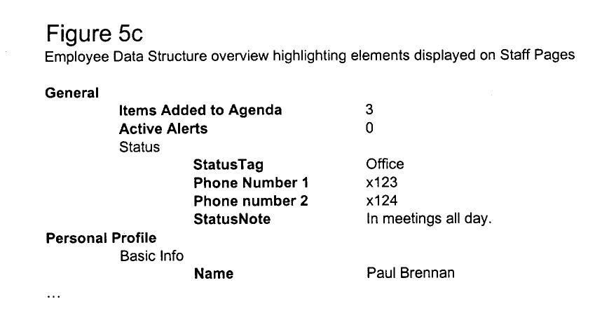

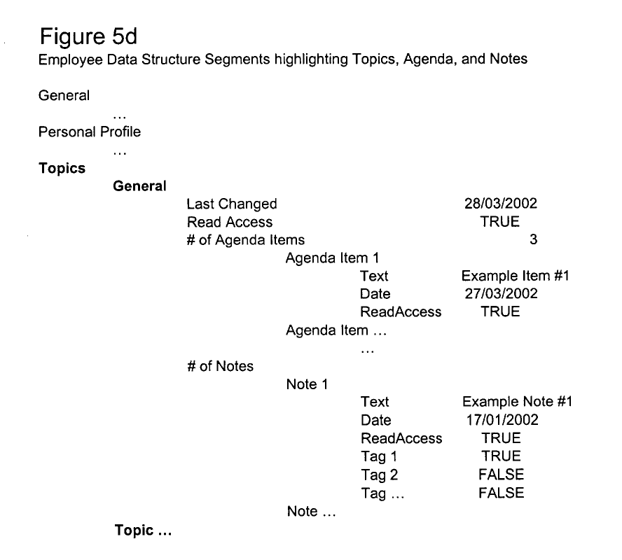

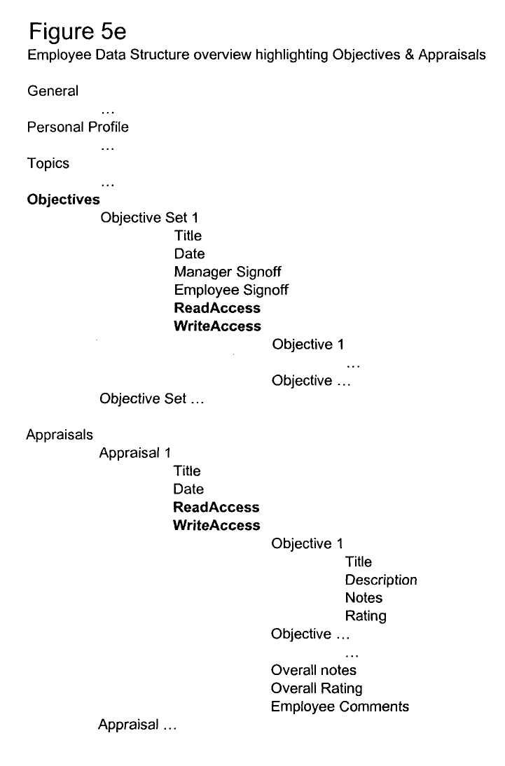

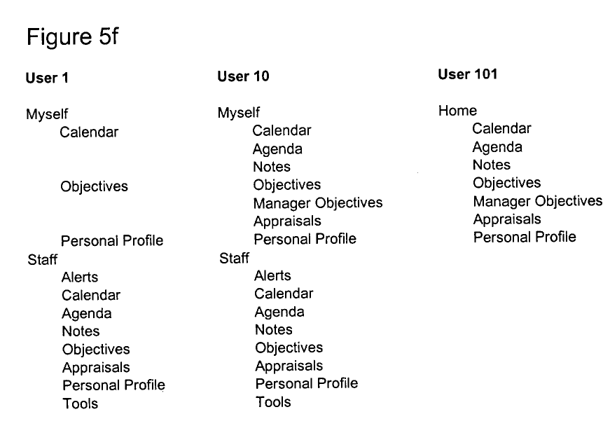

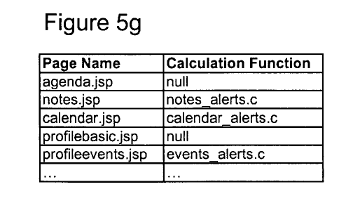

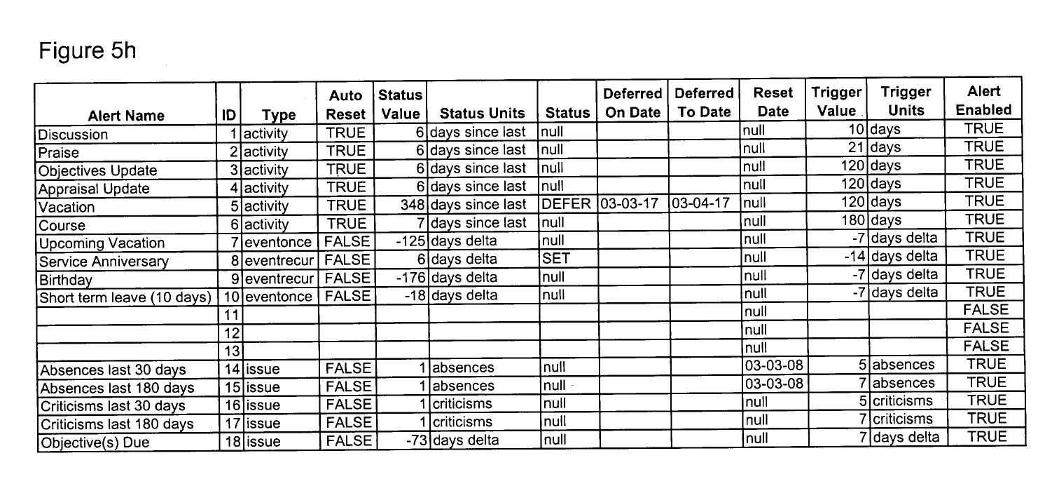

In an intranet based system supporting large numbers of user terminals, it becomes more likely that some of the data described in FIG. 5 may be available on existing servers prior to the introduction of the invention (e.g. personnel data, corporate organization structure data). In this case, the application server 5 can run customized software to provide its features based on a combination of the application server's data stored at its data storage device 8, with pre-existing data stored on internal server 600. The user utilizing a user terminal need not be aware that the data is coming from multiple data stores.

A “first time” user of the invention, in the implementation described in FIG. 1a, would start by accessing on a user terminal the application software over the internet 20 using their internet browser. They would obtain access identification and a password to the application in exchange for payment, e.g. by credit card. In the case where a user is associated with other users within a larger organization, that larger organization may be billed directly, eliminating any requirement for an individual user to provide billing data.

In the implementation described in FIG. 1b, a “first time” user would be assigned a userid and password by their organization, and direct payment would not be required.

FIG. 3a illustrates an example login screen for the invention. In some environments, users may have already authenticated themselves, and may bypass this screen. Users presented with a login screen would authenticate themselves by entering their email address (or user name) and password in an appropriate location on the login screen 310,312, then pressing the login button 314.

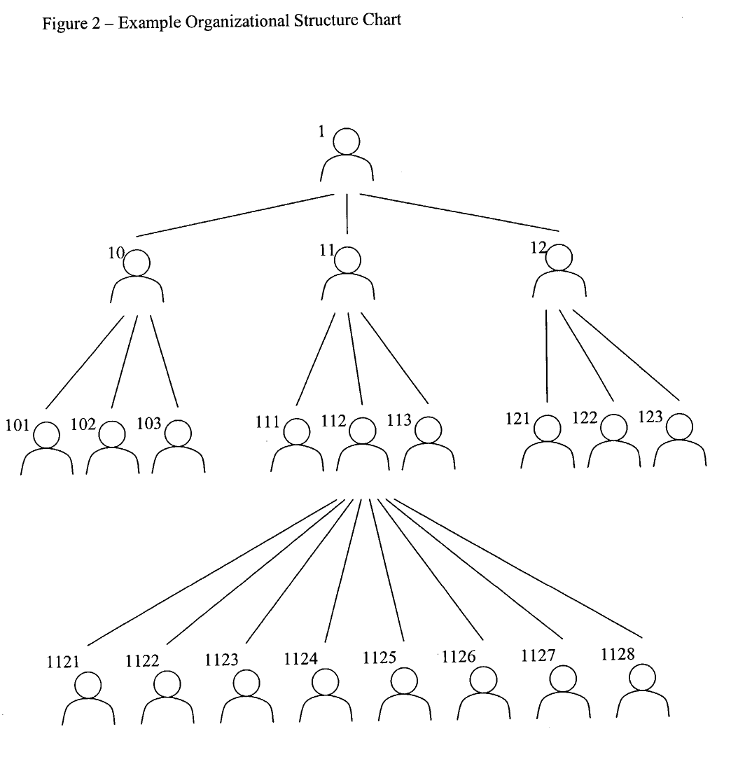

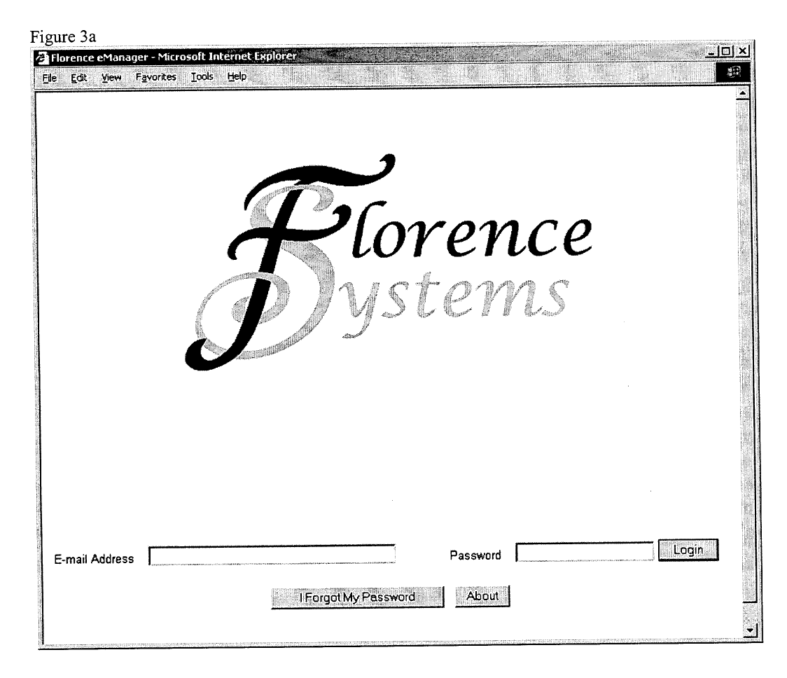

Upon accessing the system, already-authenticated users would be presented with a “home” page, offering navigation to other functions, a summary of their account status and significant information, such as pending messages from their manager or their employees or notifications “alerts” of possible issues. Users presented with a login screen would be presented with a “home” page after they have been authenticated by the system. FIG. 3b illustrates an exemplary “home” page; it offers primary navigational control through a left menu 316, as well as overall controls and functions in a top menu 318. FIG. 3b through FIG. 3gg all represent example user interface screens presented to user 11 (in the organization chart of FIG. 2), and in most cases, viewing the data of user 112 (in the organization chart of FIG. 2).

Any member of an organization, as depicted in example from in FIG. 2, can be a user of the system. Depending on their place in the organizational structure (“management chain”), they would be presented an appropriate user interface (further discussed with reference to FIG. 5f) and access to the data for their own subordinate employees.

Referring to FIG. 2 as an example organizational structure, we will presume the initial user is user 1 in the figure. User 1 would be a manager to users 10, 11, and 12, who can be referred to as user 1's subordinate employees. User 11, for example, would act in a managerial role to users 111, 112, and 113, who can be referred to as user 11's subordinate employees. User 11 would thus be a manager with respect to users 111, 112, and 113, and a subordinate employee with respect to user 1. User 1 would have three subordinate employees (User 10, 11, 12) but many employees; for example, Users 111, 112, and 113 are not User l's subordinate employee, they are still considered employees of User 1.

Thus a user can also be another user's subordinate employee. The chain of users and subordinate employees, as depicted in FIG. 2, is known as the “management chain”. Members above a particular user in the Management chain linked to that user are referred to as that user's manager; members directly below linked are referred to as that user's subordinate employee. When user 11 is using the system, he would have users 111, 112, and 113 shown in his view of his staff, a potential user interface for which is shown in FIG. 3c. This screen beneficially provides a display of or direct access to summary information about each of the user's subordinate, including:

the subordinate employee's name;

an indication of whether that subordinate employee has added items to their discussion agenda, signified by a number in the “new” field representing the quantity of agenda items added by the person since the user last looked at the subordinate employee's agenda/notes, and access to that subordinate employee's discussion agenda, by selecting the number;

any potential warnings or issues, indicated in the “alerts” field, and accessible by selecting the alert indicator;

the subordinate employee's current status, displayed and changeable by selecting the status indicator;

the subordinate employee's calendar - accessed by selecting the calendar indicator;

contact telephone numbers based on the subordinate employee's current status, displayed in the telephone number field;

supplemental access to each subordinate employee's ongoing discussion agenda, by selecting the person's name;

Note that the subordinate employee list in FIG. 3c may be advantageously sorted so that those employees with active alerts or new notes would be presented at the top of the list, to facilitate a quick scan of employees requiring attention where all employees can not be displayed simultaneously.

All, or portions of, the subordinate employee list shown in FIG. 3c may also be advantageously presented within the framework of an information portal, where the portal has appropriately authenticated the accessing user's rights to such information.

The user can act in an employee mode by selecting his own data, for interacting with his manager, or can act in a manager mode for interacting with his subordinate employee's data, through selections made in the hierarchical navigational menu. The status indication (320) at the top of the screen provides constant feedback as to whose data is being accessed.

Data defining the user's employees could be entered by the user, using typical internet-based data entry forms; or by an organizational administrator on behalf of the organization; or via transfer of a file, e.g. a comma-separated-value format description of the data, imported or collated from other systems or lists; or via a data connection to another system, e.g. a Human Resources Information system—such a Human Resources Information System may be connected as internal server 600 in FIG. 1b; all through means well known to those skilled in the art. It should be noted that in a larger organization, with many layers of managers and employees, it would be possible to make use of this invention, starting top-down, with implicit definition of the organizational structure as each manager in turn filled in their employee's data.

FIG. 5c describes the elements of each user's data structure which is used to display the subordinate employee list; their name, number of items added to the agenda, active alerts, current status, phone numbers associated with current status, and any note associated with current status.

FIG. 3d shows a user's view of the alerts associated with a single subordinate employee (the “alerts screen”). The Alerts subject column lists the possible alert events; the status column shows the current state of the data which would cause an alert; the action column offers specific actions for dealing with any particular alert; the Alert Trigger column shows the thresholds which would trigger an alert. Triggered alerts are shown in a highly visible graphical treatment, e.g. a high-contrast high brightness colour, such as red.

Alerts can be “deferred” to a future date by the user, in which case they are shown highlighted in a less visible fashion, e.g. in bold-face text.

The system advantageously provides direct access to the typical activities a user would conduct in the event of an alert, e.g.:

Deferring the alert, when it is likely to be resolved without other specific action by the user, until a specific date in the future;

Sending an email to the subordinate employee regarding the situation which has triggered an alert;

Adding a note to the subordinate employee's ongoing discussion agenda for the purpose of discussing the situation leading to the triggering of an alert in the future;

Resetting the alert where the situation is resolved, and the user wishes to be advised of the next alert.

It should be noted that some classes of alerts require a user to specifically reset them, where some user action is likely warranted beyond the scope or knowledge of the invention; however, where the invention can make advantageous use of its own data, it automatically resets the alert on behalf of the user. For example, if an alert is raised due to the user not having had a discussion with the subordinate employee in the prescribed interval, that alert is automatically reset when any note is added to that subordinate employee's topics data structure.

It should be noted that the ability to select one of or scroll through each of the user's subordinate employees, or their own data, is easily supported in such contexts as this Alerts Screen, allowing a user to very quickly scan the status of all their subordinate employees. Using the top menu, the user can directly select from their staff, displayed in a drop-down menu, or choose to cycle sequentially through their subordinate employees, by choosing “next” and “previous” controls, which result in the system selecting the next or previous subordinate employee from the list of that user's subordinate employees. FIG. 5a represents a portion of a database defining the organizational structure of a group of users (the same organizational structure shown in a more traditional format in FIG. 2), and the list of which users should be displayed as subordinate employees of the current user would be identified in columns “Staff 1” through “Staff . . . ”.

Typical alerts and example thresholds are shown, but other metrics and alert thresholds can be defined, days tardy, customer complaints, low productivity, high productivity, etc., can be manually entered by the user, the subordinate employee, or fed from a third party source, such as at server 600 in FIG. 1b.

FIG. 3e shows further details of the user interfaces associated with the Defer, and Add to Agenda screens for the Alerts Screen. The Defer Screen allows the user to specify the date to which the alert is to be deferred, and notifies the user of the current deferral date if there is one.

The Add to Agenda screen allows the user to describe the subject of discussion for adding to the agenda, optionally to reset the alert if this alert requires manual resetting, and optionally choosing to identify this agenda item for sharing with the subordinate employee (the ability to share or not a particular agenda item or note with a subordinate employee is further described in reference to FIG. 3h). Two versions of this screen are shown, highlighting the fact that some alerts are manually reset, some automatically.

FIG. 3f shows a calendar screen which allows the user to view a calendar for a subordinate employee, describing the subordinate employee's status for each day in a particular month (and those days from prior and subsequent months which share a work week with the selected month). Access to any particular day's details for the purpose of viewing or changing is available by selecting that day, which accesses the mechanism shown in FIG. 3g.

FIG. 3g shows a Calendar Details Screen which allows the user to view subordinate employee contact information for any given day, for example, any relevant notes for that day, and also in the event that an unusual calendar event has been overlaid onto the weekly default repeating calendar, the beginning and end days for that unusual calendar event. Notes for unusual calendar events are also displayed at the bottom of FIG. 3f. Mechanisms to choose and display months other than the current month are included on the display, as arrow keys to either side of the month and year display

FIG. 3h illustrates the user interface for adding and managing discussion agenda items. The Topic column lists the discussion topics; it includes a “general” area, as well as user-defined discussion topics, shown in this example as “Customer Svc Response”, “Dept. Cost Containment”, “S/W Quality - X-Ray”, and “Testing Knowledge”. The screen offers the ability to add agenda items associated with any of the topics, and optionally to share those items with the subordinate employee, indicated by the checkbox underneath the folder icon associated with each agenda item. Also offered is the ability to add a note to a discussion topic in the notes file, again, optionally shared with the subordinate employee. Existing agenda items can be moved to the notes, e.g. after a discussion; this advantageously minimizes the amount of data entry by the user. Existing agenda items can also be simply deleted, where no note is required.

The upper window in FIG. 3i shows the pop-up window associated with adding or moving a note. It allows a date to be associated with the note, defaulted to the current date; text for the note, defaulted to the current agenda item; an option to leave the original agenda item untouched, controlled by the “leave on agenda” tickbox; options to tag the note, shown in this example with “happy face” and “sad face” icons (for later use in collating notes, e.g. for the purpose of appraisal), representing praise and criticism; and an option to share the note with the employee, shown by the shared-folder icon, which modifies a Read Access field.

Referring back to FIG. 3h, discussion agenda items/notes added by the employee are also shown on this screen (i.e. the item referring to extending a vacation in Washington), with a different graphical treatment (i.e. font style and text colour). This permits the user to clearly differentiate subordinate employee's additions to the agenda from their own items.

The lower portion of FIG. 3i shows the mechanism used for adding user-defined discussion topic; it includes an option to share the topic with subordinate employees.

The system allows for the user to selectively share specific data elements with individual subordinate employees; FIG. 5b summarizes the elements of data for which such control is offered, i.e.:

Overall access to the data, controlled by Login Access. If the subordinate employee is not given Login Access, they are not shown any information at all. Login access grants implicitly certain rights—the ability to add agenda items, the ability to add discussion topics, and the ability to add objective sets;

Visibility of a discussion topic, controlled by the Read Access field associated with each topic. If a subordinate employee has no access to a particular discussion topic, they system does not display the discussion topic to that employee when they are accessing pages listing discussion topics. As a convenience to the user interface design, the system maintains the General topic as fixed, always with Read Access enabled.

Visibility of individual agenda items, controlled by the Read Access field associated with each agenda item.

Visibility to individual notes, controlled by the Read Access field associated with each agenda item.

Visibility of each objective set, controlled by the Read Access field associated with each objective set.

Ability to modify each objective set, controlled by the Write Access field associated with each objective set.

Visibility of each appraisal, controlled by the Read Access field associated with each appraisal.

Ability to modify the employee comments portion of each appraisal, controlled by the Write Access field associated with each appraisal.

It will be clear to those skilled in the art that sharing controls can be modified in a variety of ways depending on specific requirements of the organization using the invention, adding additional controls or simplifying controls where appropriate.

FIG. 3j illustrates an exemplary user interface providing a summary view of and controls for discussion topics, previously discussed with reference to the Agenda function. The user is presented with a count of agenda items and notes associated with each discussion topic, and the date of the last change to any datum associated with the topic. The subordinate employee's ability to view each discussion topic is also shown and controllable.

FIG. 3k illustrates a specific set of notes, in this example, the “Customer Svc Response” discussion topic's notes. The features of a note have been discussed with reference to the Agenda function. This exemplary user interface shows all of the added notes, offers the ability to add additional notes, delete notes, and change the sharing or tags associated with each note. FIG. 5d illustrates an exemplary data structure for the discussion topics, agenda items, and notes features of the invention.

FIG. 3l illustrates the calendar view of discussion notes; this allows a manager to quickly see the pattern of discussion across discussion topics over time, and to select the notes for any particular date, by selecting the date of interest, or for a particular discussion topic across all dates, by selecting the discussion topic of interest. Selecting a date takes the user to a point in the user interface described in FIG. 3n; selecting a discussion topic takes the user to the point in the user interface described in FIG. 3k. The presentation of information in FIG. 3l can be condensed, eliminating days in which no discussion occurred; this is shown in FIG. 3m.

FIG. 3n shows a consolidated view of notes on the employee's discussion topics for a single day. The user can scroll through other meeting days with the buttons to either side of the date, shown near the top of the screen. The user can also advance immediately to the first discussion notes stored, or to the most recent discussion notes stored. If the user wishes to modify notes, or see the detailed notes for a particular topic, they can access that discussion topic by selecting the topic name, which takes them to the point in the user interface described in FIG. 3k. The user can return to the multi-day view by selecting the appropriate button on the user interface.

In the event that a particular discussion topic becomes obsolete and is not required at all, it can be deleted completely from the subordinate employee's database. Older topics for which notes are advantageously maintained can be “archived”; archiving a note removes it from visibility within the database, but allows it to be accessed through an alternate user interface mechanism. This mechanism is not specified herein; such techniques are well known to those skilled in the art.

Archival is advantageously permitted for a complete discussion topic, or for a particular subset of dates, allowing, for example, a particular calendar year's notes to be maintained as a set.

FIG. 3o illustrates the portion of the user interface used to summarize and maintain (add, modify, delete, archive) employee objective sets (each set contains one or more individual objectives, advantageously collected into a set). Subordinate employee access to objective sets is controlled herein as well. Selecting a particular objective set would take the user to the portion of the interface shown in FIG. 3p.

FIG. 3p illustrates the portion of the user interface used for viewing and modifying an objective set. The user can add new objectives, edit objectives, and delete objectives. The invention allows for each created objective to be linked to an existing objective within the management chain; the upper window in FIG. 3s shows the portion of the user interface used to add an objective, allowing for the objective to be titled, have appropriate dates stored, details stored, establishing that linkage to a manager's objective, and advantageously creating a discussion topic associated with the objective. An objective which is not related to a manager's objective is left “Independent”. The means to create a discussion topic associated with an objective greatly facilitates the maintaining focus on an objective as the user continues with day-to-day management activities, as the discussion topic is visible on the agenda, and is not relegated to memory. Further, the discussion topic allows for collection of notes associated with the objective, facilitating performance appraisals.

From the user interface illustrated in FIG. 3p, the user can also view the relationship between the subordinate employee's objectives and their management chain's objectives (ie. the objectives of the user, the user's manager, and anyone above the user in the management chain). A view of all the subordinate employee's objectives' titles and their relationship to the management chain's objectives' titles is shown in FIG. 3q, which is access through the “Show Cascade View” button shown on FIG. 3p. From this view, or from the view shown in FIG. 3p, the full text of a specific objective can be shown as it relates to the full text of the linked management chain's objectives; this “full cascade” view is shown in FIG. 3r.

FIG. 3t shows the user interface that provides for appraisals. When a user adds a new appraisal, it is based upon existing objectives; FIG. 3u illustrates the user interface for adding a new appraisal, which provides means for naming an appraisal, selecting the objective set(s) the appraisal is to be based on, and setting the sharing controls for the appraisal.

FIG. 3v illustrates the user interface for viewing an appraisal, in summary form, listing each of the current objectives, an associated rating choice, and an overall rating. Rating descriptions can be customized to use the terminology required by the organization using the invention. Methods are provided to add additional objectives, in the event that the appraisal should cover tasks not originally described within the objective sets. Methods are also provided to import an existing appraisal, which allows, for example, an end-of-the-year annual appraisal to include, without modification, a previously-completed mid-year appraisal for reference. A method to view the details of the appraisal is also provided, which would present the view shown in FIG. 3w.

FIG. 3w describes an exemplary user interface for a detailed view of an appraisal; it provides for viewing and modifying the details supporting the ratings for each of the objectives. The function “Import Notes” associated with each objective, allows the user/manager to scan, filter, and copy previously made notes to the appraisal which are relevant to the performance of the employee with respect to the objective. FIG. 3x shows the mechanism by which the user chooses which discussion topic's notes to scan, and FIG. 3y shows the scan and select interface. The user can advantageously sort notes by tag (in this case, the tags praise and criticism are shown), or by date, and then select those notes which are considered to be relevant to the appraisal. Once selected and confirmed, the user is returned to the point in the user interface shown in FIG. 3w, with the selected notes inserted into the supporting text for each objective. The notes can be further modified or added to as required. FIG. 5e describes an exemplary data structure for the objectives and appraisals features of the invention.

It will be apparent to the reader that these elements of the invention will greatly facilitate accuracy and speed in collating information to complete an employee appraisal.

FIG. 3z illustrates the user interface presenting a first portion of the subordinate employee's personal profile: the basic information. This stores identification information, used in the application for communications, directory, and access, as well as providing information on the subordinate employee's use of the system and current access status. The user interface provides a mechanism to reset the subordinate employee's password in the event that they require this; it is also apparent to those skilled in the art that a system administrator could do this, and a subordinate employee themselves may be able to reset their own password using an identity confirmation procedure.

FIG. 3aa illustrates the user interface presenting a second portion of the subordinate employee's personal profile: the home information. This stores information regarding the subordinate employee's home addresses: physical, postal, and electronic mail. Advantageously provided is means to connect the user to internet-based mapping software providing a road map showing the subordinate employee's home and driving directions to it.

FIG. 3bb illustrates the user interface presenting a third portion of the subordinate employee's personal profile: the telephone contact information. This information allows all of the subordinate employee's telephone numbers to be stored for reference by the user, as well as providing automatic associations between these telephone numbers and various calendar statuses. This permits the calendar status to be associated by default with specific telephone numbers, and thus the features on the staff page and directory which allow current telephone numbers to be displayed for each user. Each calendar status may advantageously be associated with up to two telephone numbers.

FIG. 3cc illustrates the user interface presenting a fourth portion of the subordinate employee's personal profile, the calendar defaults. This information allows the calendar to automatically default to specific statuses for specific days, allowing subordinate employees who do not regularly work in the office Monday-Friday to store their personal default schedule. For example, a subordinate employee might work Tuesday-Saturday, or might work from home (i.e. telecommute) two days each week. This portion of the invention allows for the calendar to automatically reflect these default status patterns.

FIG. 3dd illustrates the user interface presenting a fifth portion of the subordinate employee's personal profile, the personal development information. This allows the user to store relevant information regarding the subordinate employee's personal development plans, needs, etc., so that the user can refresh their memory regarding this information as appropriate.

FIG. 3ee illustrates the user interface presenting a sixth portion of the subordinate employee's personal profile, the table of personal event dates. This feature allows the user to store key dates relevant to the subordinate employee, which can then be used to trigger alerts, discussed in reference to FIG. 3d. Standard dates are pre-labeled; other dates are labeled accordingly. Dates can be automatically recurring, as in the case of birthdays and anniversaries, or non-recurring for other events. Specific alert parameters can be set for each date, allowing the user to receive a reminder in advance of a date, on the date, or some period after the date.

FIG. 3ff illustrates the user interface presenting the seventh portion of the subordinate employee's personal profile, the family information. This information is used to remind the user about the subordinate employee's family, facilitating work social interactions. The subordinate employee's family names can be recorded, as well as other information which the user considers important.

FIG. 3gg illustrates the user interface presenting the eighth portion of the subordinate employee's personal profile, the miscellaneous information. This allows the user to store arbitrary information about the subordinate employee which may be important in understanding and building a rapport with the subordinate employee. Arbitrary labels can be associated with arbitrary information, depending on the user's knowledge and desire to store specific information.

FIG. 3 (all parts) show a manager's view of the data. FIG. 4 (all parts) shows some exemplary portions of the user interface for a subordinate employee to view their own data. Subordinate employee accounts can be automatically set up and communicated to the subordinate employee via email, in both of the system architectures shown in FIG. 1a and 1b, through the addition of an email component added to server 5 (such components are well known to those skilled in the art).

It should be noted that most users are also subordinate employees, reporting to yet another user (their manager). The system provides these users the ability to access both their own data, as shared by their manager, and that of their subordinate employees, through the navigational mechanisms at the left of the screen. FIG. 5f summarizes the navigational tree for users 1, 10, and 101 illustrated in the organization chart of FIG. 2. User 1 has full manager access, but limited subordinate employee functions, as he does not exist in a subordinate employee role within the organization. The limited functions allow him to establish his own calendar and personal profile, for the purposes of the directory, and his own objectives, for the purposes of allowing those to be view and linked to by his subordinates. User 10 is both manager and subordinate employee, and is offered full subordinate employee and manager functions. User 101 is only a subordinate employee, with no managerial responsibility, and is offered only subordinate employee functions, with an appropriately simplified labeling in the navigation structure.

All of FIG. 4 is shown from the point of view of user 112, acting as a subordinate employee within his relationship with user 11. FIG. 4a shows the initial system view for the employee portion of user 11's data.

FIG. 4b offers the subordinate employee a view of their calendar, and access to mechanisms to change it (which are the same mechanisms used by the manager).

FIG. 4c shows a subordinate employee's view of the agenda items for future discussion with their manager (those that the manager has chosen to share with them), and the mechanism the subordinate employee can use to provide notes to their manager for the agenda. Note that the subordinate employee is not offered any views of the data of the other subordinate employees at his level of the management chain.

FIG. 4d shows a subordinate employee's view of the topics summary; it is similar to the view of the manager, but does not list topics which are not shared, nor does it offer topic management functions (e.g. delete).

FIG. 4e shows a subordinate employee's view of a particular topic's notes, showing only those notes which the manager has chosen to share with them. No ability to modify or manage notes is provided to the subordinate employee.

FIG. 4f shows a subordinate employee's view of his objectives summary, showing only those objective sets which the manager has chosen to share with them. Ability to modify an objective set depends on whether the manager has given them such permission (indicated by the checkbox under the “write” icon column). Subordinate employees are always given the ability to adjust the sharing of their own objectives further down the organization management chain. For example, user 112 has not chosen to share their objectives (indicated by no selections in the share-1 and share-all columns). These columns would allow user 112 to share their objectives with their direct subordinate employees, or employees at all levels of the management chain, respectively. Note that in FIG. 4f, one of the two objective sets has been “signed off” by both manager and subordinate employee. The other has not, and the subordinate employee is offered means to sign off that objective set.

FIG. 4g shows a subordinate employee's view of an objective set, which they do not have modification permission for. They are not presented with means to modify or add to the objective set. If they did have modification permission, their view would be identical to that of the manager's, in FIG. 3p.

FIG. 4h shows the subordinate employee's view of a summary of their manager's objective sets (those which have been selected for sharing by their managers at all levels in the management chain). As discussed in reference to FIG. 4f, each manager has the privilege of sharing (or not) their own objective sets with employees underneath them in the management chain, selectively to their subordinate employees, or to their employees at all levels.

FIG. 4i shows the employee's view of the details of a selected manager's objective set.

FIG. 4j shows the employee's view of a summary of the appraisals which their manager has chosen to share with them. If the subordinate employee has permission to modify subordinate employee comments, an indication is shown under the “write” icon column.

FIG. 4k shows the subordinate employee's view of a summary of a specific appraisal. They have no means to modify the appraisal.

FIG. 4l shows the subordinate employee's view of the details of a specific appraisal. In this case, the subordinate employee has been given permission to modify the subordinate employee comments, and the subordinate employee comments field is editable, with means to save or cancel the changes provided.

The subordinate employee can access the basic parts of their profile (basic information, home information, telephone information, calendar information), for the purpose of verifying and maintaining the data. Each subordinate employee is also provided access to a directory preferences portion of their profile.

FIG. 4m shows the user interface for a subordinate employee to modify their directory preferences. This screen allows the subordinate employee to determine whether they generally wish to share status, calendar, and specific telephone information with those in the organization who are not in their management chain.

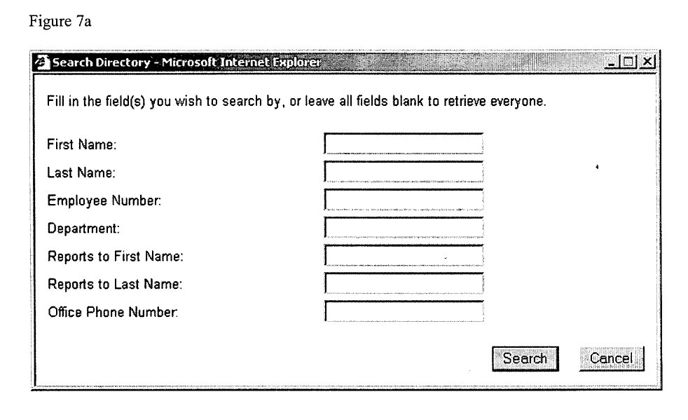

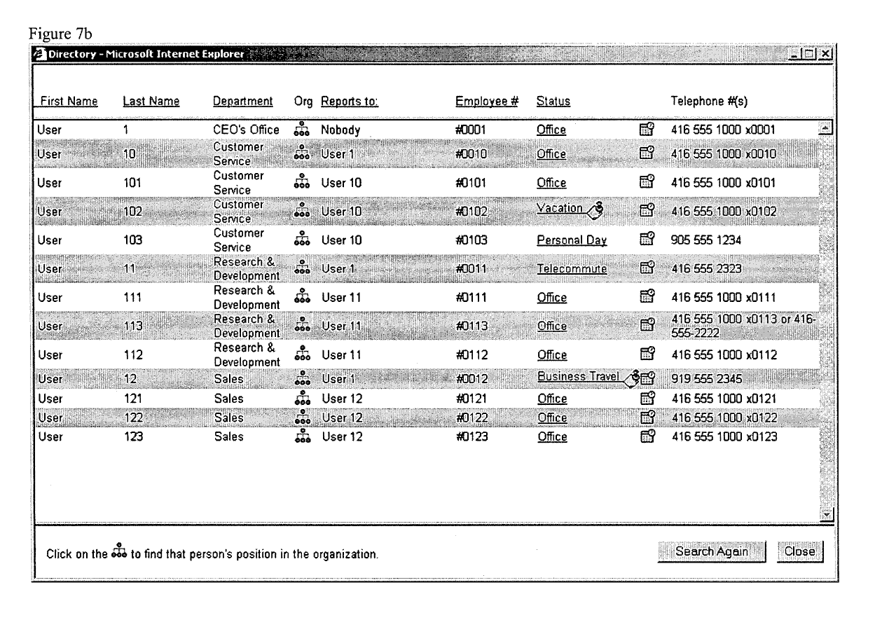

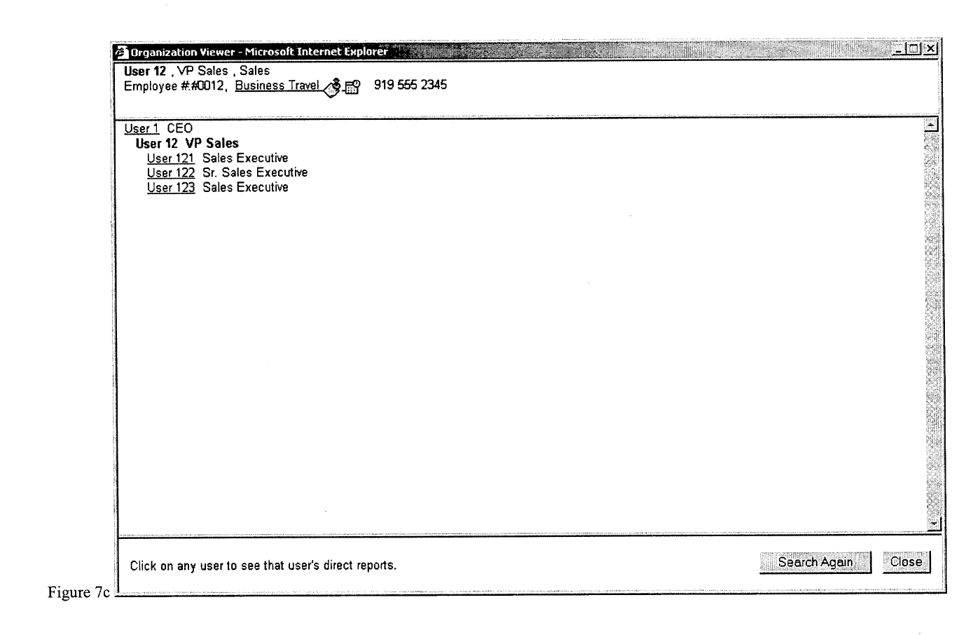

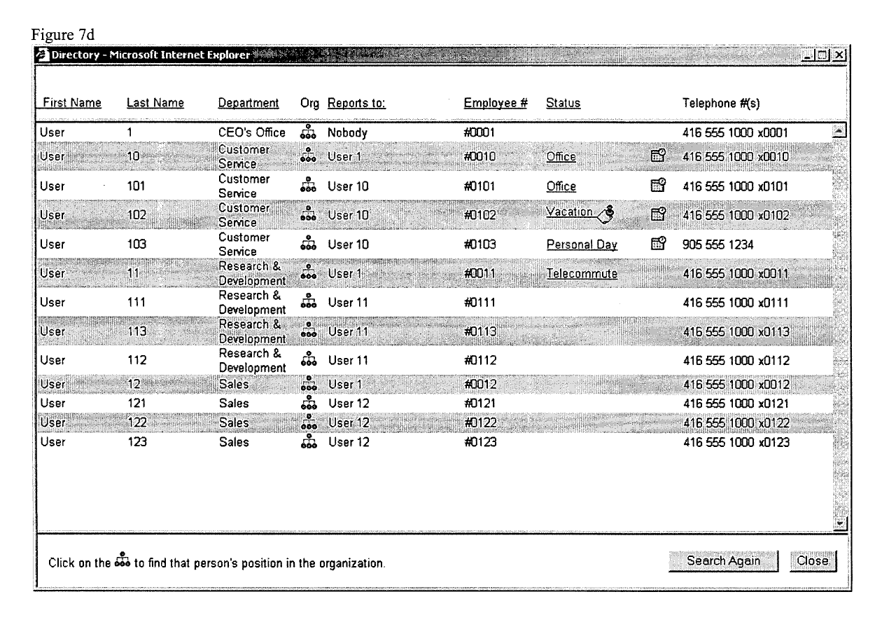

FIG. 7a is an example of a user interface for searching a directory, similar to many known in the art.

FIG. 7b is an example of a user interface showing a complete directory (all users retrieved) for the upper 3 tiers in the management chain depicted in FIG. 2. In this case, the user interface is what user 1 would see in their directory. In addition to traditional directory information, the invention shows the status of the subordinate employee, current phone numbers, and a link to the user's calendar, in those cases where the subordinate employee reports directly or indirectly to the person viewing the directory, as is the case for all directory entries in this example. Status, status notes, and calendars can all be viewed only (not changed) within the framework of the directory. The directory also provides means for the user to view the organization structure, as shown in FIG. 7c.

FIG. 7c shows the organization view, centered on user 12, displayed by user 1. User 1 has privileges to see the status, telephone numbers, and calendar of all users, so the selected user's complete information is displayed at the top of the page. The organization view shows the selected user “centered”, with a different graphical treatment. It shows the selected user's management chain to the top of the organization (in this case, just user 1), and any staff reporting to the selected user (in this case, users 121, 122, and 123). The organization can be “browsed” by selecting any of the displayed entries. For example, clicking on user 1 would show all of their reports (user 10, 11, and 12); one could then continue to click on various displayed users, navigating up and down the organization.

FIG. 7d shows a different directory view, in this case, one displayed for user 10. The user can only see the status information for their own staff, and one additional individual, user 11, who in this example has configured their directory preferences to allow for the sharing of their status and telephone number with other users.

The framework and data structures of the invention allows additional specialized tools to be provided, such as an employee familiarity function, which can present to a user arbitrary random subordinate employees' pictures and information, allowing the using manager to become more familiar with employee faces and associate names with them. The employees could be selected from the organization as a whole or through some organizational subset or, for instance, limited to the user's employees at all levels. This function can be added to a user homepage, as shown in FIG. 3a, or other equally appropriate parts of the user interface.

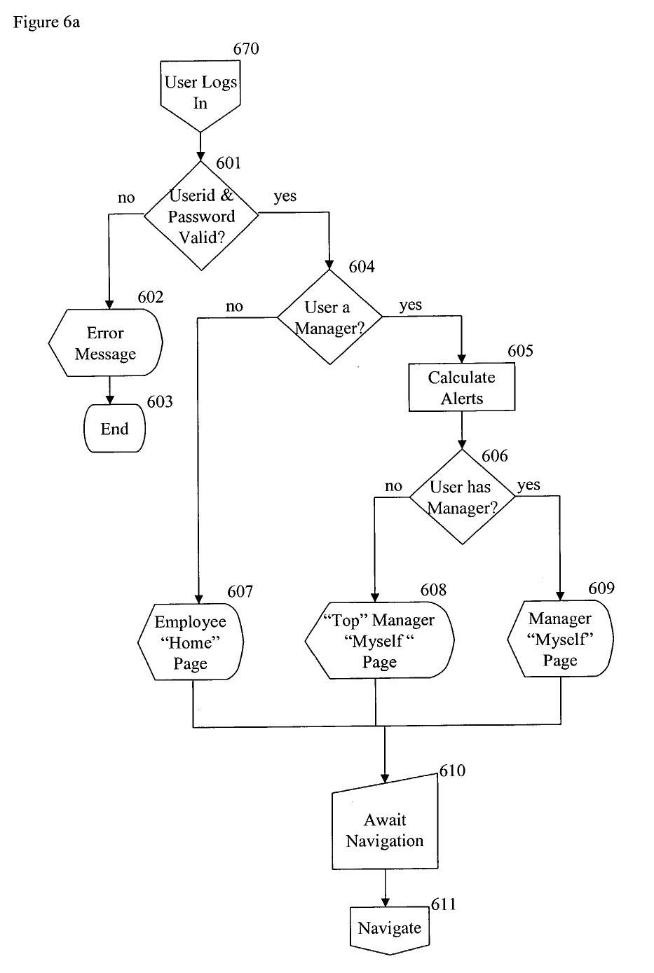

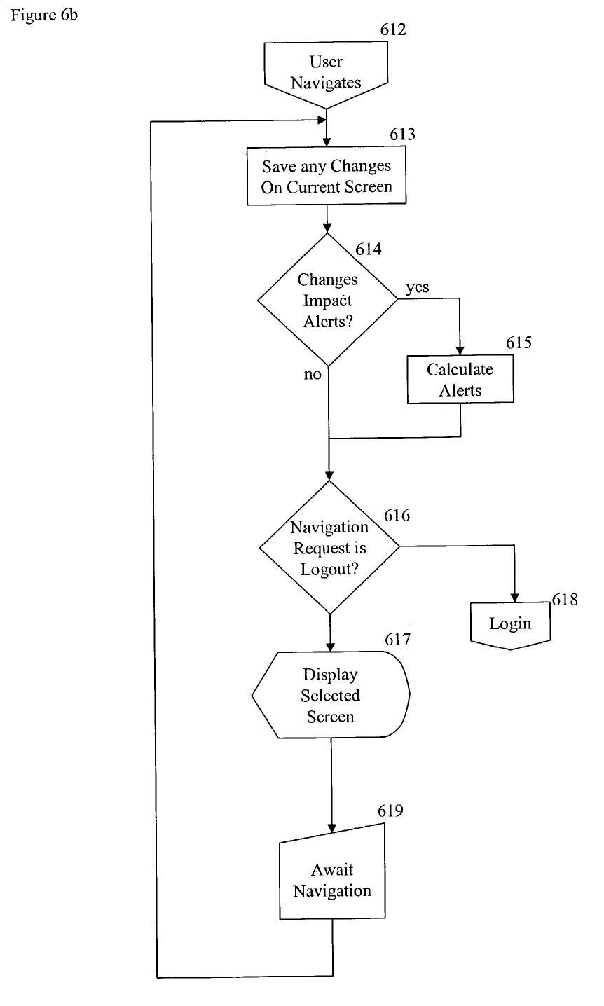

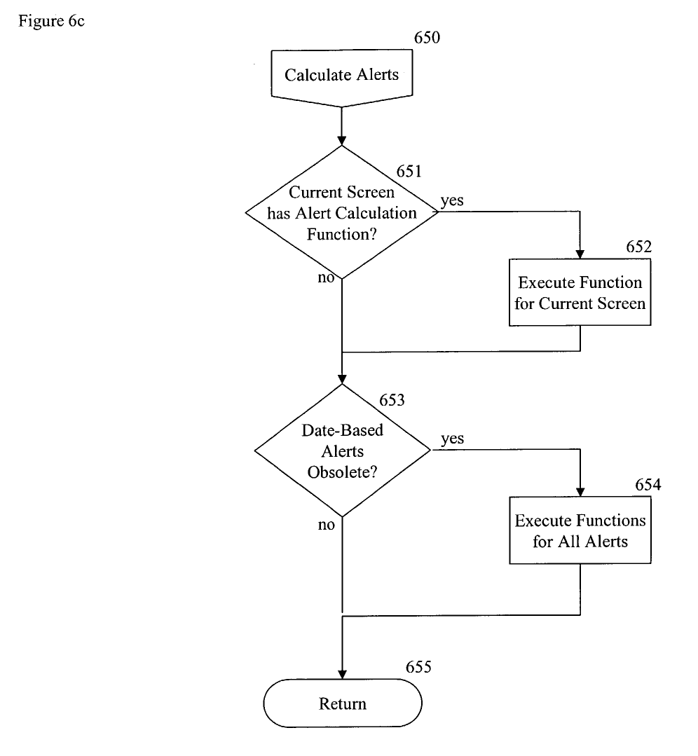

FIG. 6a and 6b describe the overall flow of the invention. At step 670, the user logs in, with an interface equivalent to that described with reference to FIG. 3a. The user id and password are verified at step 601, and if invalid, the user is informed of this at step 602, and the application effectively terminates at step 603 (usually by restarting and allowing the user to attempt a subsequent login; in some cases, common security heuristics are used to block further attempts). If valid, the invention determines if the user is a manager, at step 604, and if so, calculates the alerts for the manager's subordinate employees at step 605 so that they can be summarized and appropriately displayed for the manager. The invention then determines at step 606 (from data exemplified in and described with reference to FIG. 5a) if the manager is a subordinate employee themselves, and if not, presents at step 608 a version of the interface described in FIG. 3b with the navigation structure limited for this circumstance (as described in FIG. 5f).

If the user is a manager and is also a subordinate employee themselves, an unlimited version of the navigation structure is provided, at step 609. If the user is not a manager, the employee version of the navigation structure is presented, at step 607.

The invention allows for intra-page processing as part of the display step (as is well known within web-based applications), and generally awaits user input in the form of a request for navigation to a new part of the application, at step 610. When a request for navigation is received, the application proceeds through steps 611 and 612 to step 613, where any changes made in the current screen are saved if necessary (thus eliminating any requirement for the user to save their data entry manually). At step 614, a determination is made to see if alerts need to be recalculated, due to actions in the current screen. If so, alerts are recalculated at step 615. In either case, the application then proceeds to step 616, where a determination is made to see if the navigation request made was to log out. If so, the application proceeds via step 618 back to step 670, for a subsequent login.

If the navigation request was not to logout, the requested page is now displayed and processed at step 617. Again, the application then handles intra-page processing and awaits a navigation request at step 619, at which point it returns to step 613.

At steps 605 in FIG. 6a and 615 in FIG. 6b, alerts are calculated. FIG. 6c describes the overall process involved in this calculation. At step 651, the invention determines if the current screen impacts alerts in any way; it references a table such as that in FIG. 5g, listing the java server pages providing the screens, and where appropriate, an alert calculation function that is to be called if the particular page requires it. If the alert calculation function is “null”, no calculation is required or performed. If the function is not null, it is executed at step 652.

At step 653, the invention determines if the time-based alerts are obsolete. A comparison of whether the current date (at the time of the calculation) is the same date as the last calculation date is made. This handles users who have not yet logged in this day, and users who have been logged in over the midnight hour. If the alerts are obsolete, all the alerts are recalculated at step 654.

The displaying of the alerts screen (as shown in FIG. 3d) is driven from a table such as that described in FIG. 5h. The table allows for the alert screen to be quickly built, and for summaries of alerts to be provided on the staff page and home/myself page for the manager.

The alert name is used for display purposes. The ID is used internally to allow for alerts to be referenced. The type is used in categorizing the alerts into the three categories displayed to the user, and in processing; for example, “eventonce” alerts are completely deleted from the employee events section of the personal profile once they are reset, and “eventrecur” alerts are set to reoccur on the next calendar year. The auto reset determines whether or not the user is provided with a reset button; in the example in FIG. 3d, the user can reset the active alert for the Service Anniversary, but not the deferred alert for an overdue vacation.

The “status value” shows the current status of the alert; the “status units” show how that is displayed; a special entry, “days delta” indicates that the display depends on whether the status value is positive or negative. In the example FIG. 3d, the “Upcoming Vacation”, “Birthday”, “Short Term Leave” and “Objectives Due” alerts are all indicating a negative value, which is translated by the invention to “days before”. A positive value is shown for “Service Anniversary”, which represents and is displayed as “days after”. A zero value represents and would be displayed as “days”. The same logic is applied in the trigger units display, allowing for the alert to be triggered before or after an event.

The “status” field indicates whether an alert is currently set, or deferred, or neither. If set, an alert is displayed in red on the alerts page, and if any alert is set, in red on the staff page. If deferred, an alert is displayed in boldface on the alerts page, and in boldface on the staff page. Only set alerts are described on the manager's “home/myself” page, shown in FIG. 3b.

If an alert is deferred, the “deferred on date” and “deferred to date” are used to keep track of when the alert should be returned to the “set” status.

The “reset date” is used when a manual reset is performed by the manager on one of the “issue” type alerts. This is used when calculating that alert; instead of using the number of days in the alert trigger window, only those days between the reset date and the current date are used. This allows a manager who has seen an issue and expects it to resolve to reset the alert, yet be alerted if the condition reoccurs. The trigger value and trigger units are used in calculating alerts and in the alerts screen display. Trigger values and trigger units can be adjusted by the manager through a user interface, as can whether each of the system-provided alerts are used or not, as controlled by “Alert Enabled”.

Unused alerts, e.g. alert ids 11-13, are not shown in the display. Alert id's 10-13 are used for user-defined Employee Event alerts, and only one has been defined for this employee, leaving alert ids 11-13 unused.

To this point, discussion of the invention has focussed on the accessing by one user (e.g. manager) of one user's (e.g. a subordinate employee) data. It will be apparent to that it would be advantageous to perform certain tasks simultaneously for a plurality of users.

For example, a manager might wish to create the same discussion topic for more than one person; or the same agenda item, or the same set of objectives.

In each case, the manager simply selects the set of employees for which the addition is to be made and defines or otherwise identifies the object to be added. At this point the invention merely adds the same record to the portions of the database associated with each of the selected individuals. This can be done both simply (as copies), or by reference. In the former case, each of the copies must be managed individually; in the latter, means and methods can be provided to allow the referenced item to be managed directly, with changes being reflected within the views of the referenced object relevant to each of the selected users.

It will also be apparent that for some purposes it may be advantageous to extract and present the data of multiple employees simultaneously. In most cases, this would be done as a management report. The invention's architecture permits an almost infinite variety of such reports; some examples are as follows:

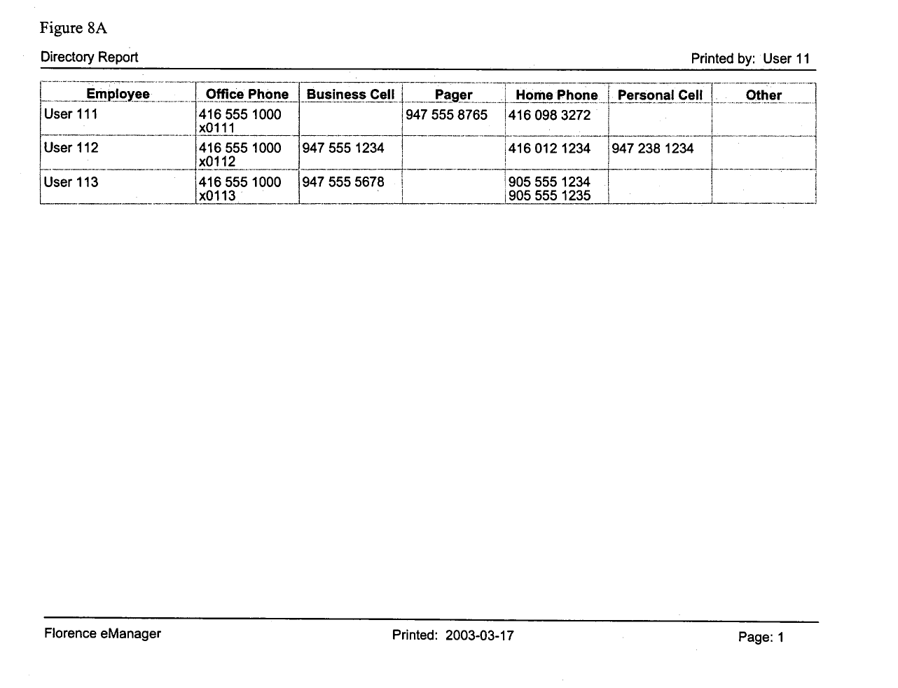

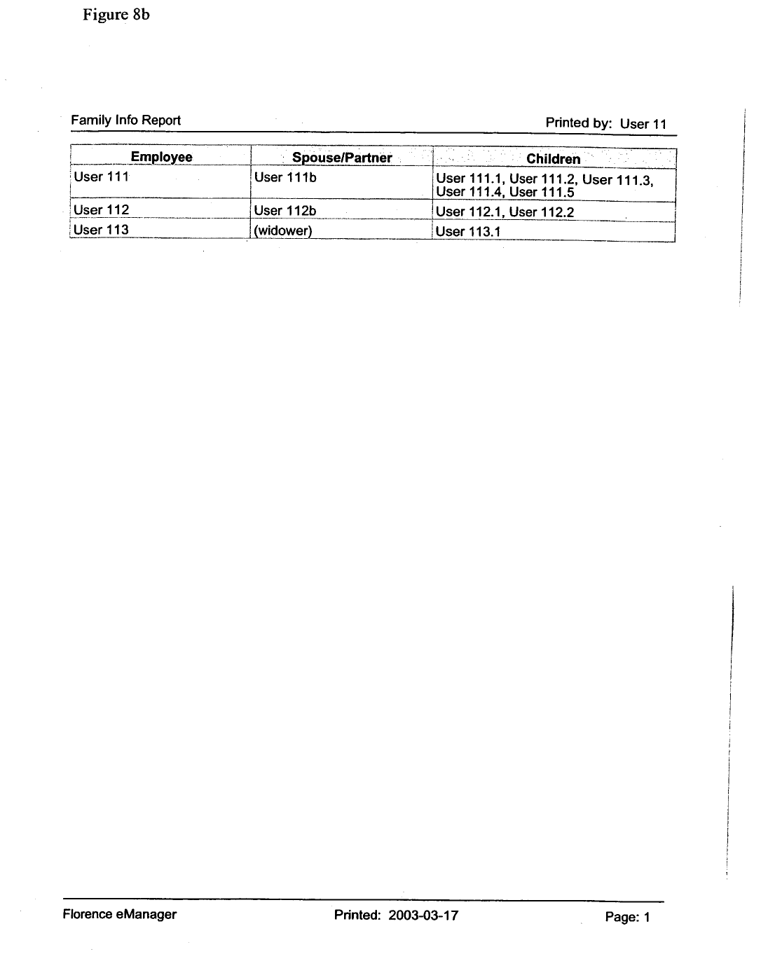

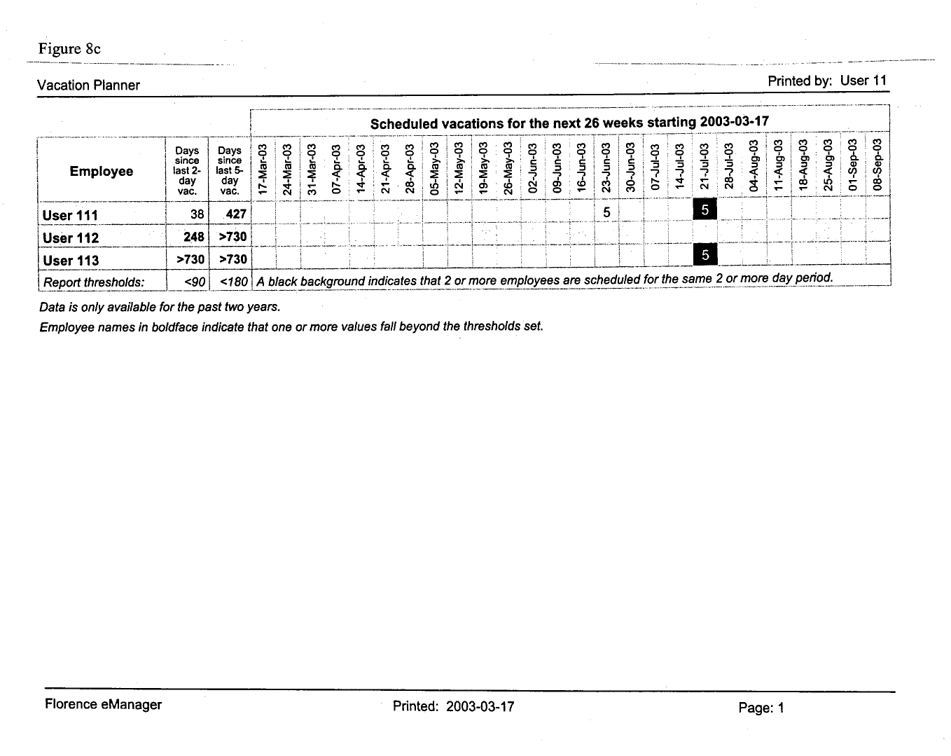

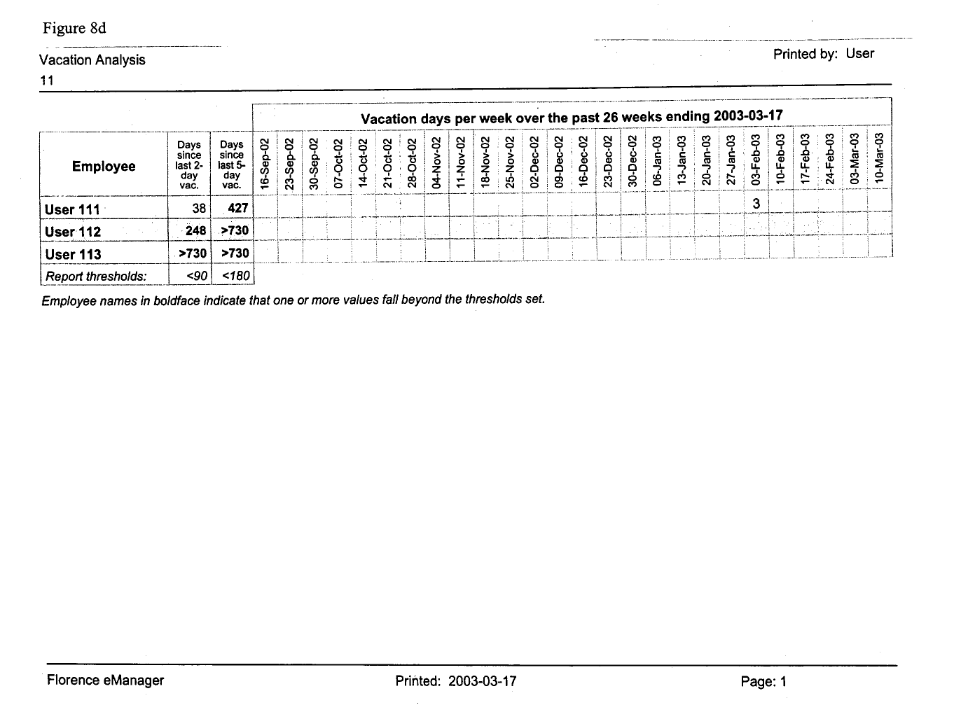

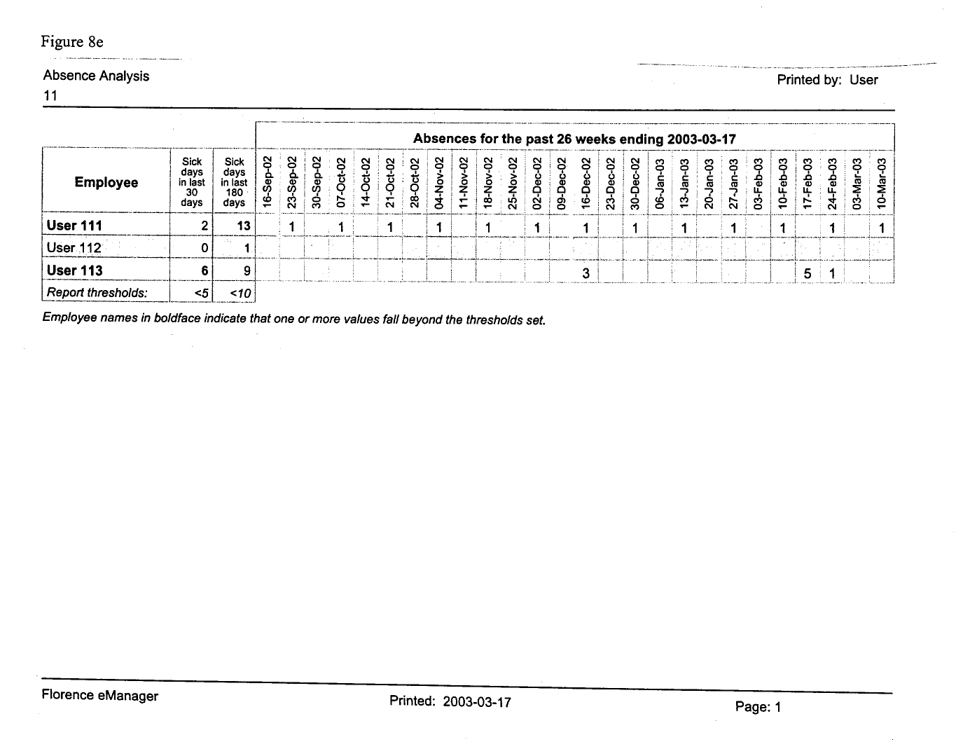

FIG. 8a illustrates a directory report, wherein the contact information of a number of employees is collated for reference, facilitating contacting employees when the manager cannot access the invention.

FIG. 8b illustrates a family info report, wherein the family information of a number of employees is collated for reference. Such information may, for example, be advantageously used when attending a social event.

FIG. 8c illustrates a vacation planning report, wherein both historical and future vacation information from a number of employees' calendars is collated. Simple analysis is also performed on the data, allowing the invention to highlight situations which should be drawn to the attention of the user, i.e. circumstances in which employees are overdue taking a vacation, and circumstances in which multiple employees have scheduled vacations for the same time period.

FIG. 8d illustrates a vacation analysis report, wherein historical vacation information from a number of employees' calendars is collated. Simple analysis is also performed on the data, allowing the invention to highlight situations which should be drawn to the attention of the user, i.e. circumstances in which employees are overdue taking a vacation.

FIG. 8e illustrates an absence analysis report, wherein historical absence information from a number of employees calendars is collated. Simple analysis is also performed on the data, allowing the invention to highlight situations which should be drawn to the attention of the user, i.e. circumstances in which absences are unexpectedly frequent. This format of report allows for absence patterns to be detected as well.

FIGS. 3, 4, and 7 describe an exemplary user interface for the invention, as implemented in a typical web-based environment, showing traditional web-based navigation tools and data entry tools. Clearly many other user interface alternatives exist and may be more appropriate as web technology matures or in the event that a client-server architecture is implemented.

FIG. 8 describes exemplary report formats for the invention, as implemented in a standard Portable Document Format. Clearly many other report formats exist.

Some or all of the functions offered in a web-based environment can be advantageously offered on smaller devices (such as a Personal Digital Assistant, e.g. the Palm PDA made by Palm Computing Incorporated), or on portable pen-based computers. This would permit the user/manager, or employee, to access and modify data when away from their usual work location, increasing the utility and availability of the invention.

Those skilled in the art will understand that a variety of modifications may be made to the preferred embodiments without departing from the spirit of the invention.

1. A human resource management system, comprising:
a) an objectives module enabling the periodic creation and storage of performance objectives for a plurality of employees;
b) a notes module enabling the periodic creation and storage of notes relating to said objectives, said system correlating said notes with said objectives for view by the user; and
c) an appraisal module enabling the periodic creation of performance appraisals for said employees, wherein said appraisal module enables the user to selectively incorporate said objectives and selectively incorporate said notes correlated thereto into said appraisal.

2. A system according to claim 1, enabling said notes to be tagged with a qualifier, said selected notes are grouped in said performance appraisals in accordance with said qualifier.

3. A system according to claim 1, including an agenda module enabling the periodic creation and storage of agenda items between an employee and a manager of said employee, said system correlating said agenda items with said objectives for view by the user.

4. A system according to claim 3 enabling a given agenda item to be selectively converted into a note, wherein said converted note inherits said correlation between the given agenda item and its correlated objective.

5. A system according to claim 3 including an alert module for notifying a user with respect to an upcoming event.

6. A system according to claim 5 enabling the dating of a note thereby to create an event actionable by said alert module.

7. A system according to claim 4, enabling said notes to be tagged with a qualifier and said performance appraisal groups said selected notes in accordance with said qualifier.

8. A system according to claim 1, enabling the definition of a management chain, and wherein said objectives module provides a cascaded view of the objectives of selected employees in said management chain.

9. A method of managing human resources, comprising:
a) periodically creating performance objectives for a plurality of employees;
b) periodically creating notes relating to said objectives;
c) correlating said notes with said objectives for view by the user; and
d) periodically creating performance appraisals for said employees by selectively incorporating said objectives and selectively incorporating said notes correlated thereto into said appraisal.

10. A method according to claim 9, including tagging said notes with a qualifier and grouping said notes into said performance appraisals in accordance with said qualifier.

11. A method according to claim 9, including periodically creating agenda items between an employee and a manager of said employee and correlating said agenda items with said objectives for view by the user.

12. A method according to claim 11 including selectively converting a given agenda item into a note, and allowing said converted note to inherit said correlation between the given agenda item and its correlated objective.

13. A method according to claim 9 including defining one or more events and periodically creating alerts for a user with respect to an event.

14. A method according to claim 13 including dating a note to create an event actionable by said alert.

15. A method according to claim 12, including tagging said notes with a qualifier and grouping said notes into said performance appraisals in accordance with said qualifier.

16. A method according to claim 9, including defining a management chain, and providing a cascaded view of the objectives of selected employees in said management chain.

17. A human resource management system, comprising:
a) means for enabling the periodic creation and storage of performance objectives for a plurality of employees;
b) means for enabling the periodic creation and storage of notes relating to said objectives, said system correlating said notes with said objectives for view by the user; and
c) means for enabling the periodic creation of performance appraisals for said employees, wherein said appraisal means enables the user to selectively incorporate said objectives and selectively incorporate said notes correlated thereto into said appraisal.

18. A system according to claim 17, including means for grouping said notes in said performance appraisals.

19. A system according to claim 17, including means for enabling the periodic creation and storage of agenda items between an employee and a manager of said employee, and means for correlating said agenda items with said objectives for view by the user.

20. A system according to claim 19, including means for selectively converting a given agenda item into a note, and means for allowing said converted note to inherit said correlation between the given agenda item and its correlated objective.

21. A system according to claim 17 including means for defining one or more events and alerting a user with respect to an upcoming event.

22. A system according to claim 21 including means for the dating of a note and means to create an event based on said note actionable by said alert.

23. A system according to claim 17, including means for grouping said selected notes to said performance appraisals.

24. A system according to claim 17, including means for the definition of a management chain.

25. A system according to claim 24, including means to provide a cascaded view of said objectives of selected employees in said management chain.
